(19) United States
(12) Patent Application Publication
(10) Pub. No.: US 2003/0097273 A1
(43) Pub. Date: May 22, 2003

(54) System and method for conducting and managing an office move

(76) Inventors: Edward D. Carpenter JR., Davis, CA (US); Brent Fitzpatrick, Sacramento, CA (US); Vann H. Brauning, Lincoln, CA (US); Samuel D. Carroll, Sparks, NV (US)

Correspondence Address: John P. Costello, Weintraub Genshlea Chediak Sproul, 11th Floor, 400 Capitol Mall, Sacramento, CA, 95814, US

(21) Appl. No.: 10/294,654

(22) Filed: Nov. 13, 2002

Related U.S. Application Data
(60) Provisional application No. 60/332,739, filed on Nov. 14, 2001.

(51) Int. Cl. G06F 17/60

(52) U.S. Cl. 705/1; 705/8; 705/9

(57) ABSTRACT

The invention is a system and method for office relocations. The invention provides a web-accessible, comprehensive and systematic approach to office relocations which identifies the specific activities to be performed in the office relocation and the internal processes required to make timely purchasing decisions for staff, contractors, vendors, furniture and equipment. The invention identifies 40 crucial tasks and over 400 associated activities designed to efficiently move an office; prioritizes, on a weekly basis, move activities according to the move date; and allows the management of the completion of activities while allowing non-managerial move team members “read only” access. The invention enhances communication with move team members, vendors and staff. The preferred embodiment is a web-based application, having calendar, task and template and project summary formats that are easy to understand. Icons allow easy file management of all daily or weekly tasks and associated templates. Color coordination defines the relationships among calendars, tasks and templates. Customized templates provide examples, sample formats, reminders, questions to ask and items to consider relating to an office move. The invention allows tasks and templates to be printed. The invention allows selected templates to be downloaded, modified and uploaded.

### BACKGROUND OF THE INVENTION

1. Cross Reference to Related Applications

This application claims the benefit of U.S. provisional patent application No. 60/332,739, filed on Nov. 14, 2001.

2. Field of the Invention

The invention relates to methods and systems for managing activities that require scheduling and organization of multiple persons, in particular, moving an office.

3. Description of Related Art

The current methods and systems for conducting and managing an office move rely on checklists and schedules. Checklists are typically developed in an Excel/Word format and identify multiple move items in no order. Schedules are typically developed in an Excel format. Schedules are used for the physical move, site deliveries and inventories. E-mail, telephone and facsimile are standard methods of communication. File retention consists of hard copies typically saved in binders by the relocation consultant or project manager.

In addition to checklists, current methods also include those described in U.S. Pat. No. 6,442,567 (Retallick) and U.S. Pat. No. 6,321,202 (Raveis, Jr.) involving various internet and computer based moving methods.

Existing methods have a number of problems. Miscommunication is common. Because move-related information is stored in multiple locations and is not easily accessible, there is often miscommunication, leading to duplicated effort or no effort. Also, because schedules can change on a daily basis, it is difficult to keep track of the most current schedule.

There is usually no system of checks and balances. Laundry lists do not define when certain activities need to be completed; there are no milestones; and there is no easy way to tell whether activities have already been completed.

Important details can be overlooked. Checklists do not take into consideration the internal approval/review/acceptance process that is required by most businesses to conduct an office move. These steps take a lot of time. Additionally, checklists do not provide samples or formats to follow. Items that may be overlooked include advertising requirements, legal considerations (e.g terms and conditions of a lease), number of competitive bids required, and signature limits and approvals, among other things.

Some important decisions may be put off or neglected. For example, just having a checklist with the words “security” and “signage” does not assist the business in making timely decisions since these services may require electrical services and dedicated telephone lines which need to be defined and ordered early in the project.

Existing methods do not clearly define the vendors' scope of work. Defining what the vendor is not going to do is just as critical as defining the scope. Defining completion dates for all activities (e.g. activities being performed by the vendor and activities not being performed by the vendor) is the key to meeting deadlines. Missing critical activities in an office move can result in change orders and can cause delays.

Existing methods often lead to the assumption that someone else is handling a given activity. It is important to identify who is responsible for each activity when multiple activities need to be completed in a short time frame. For example, typical checklists do not address the responsibilities of the landlord, contractor and architect.

Checklists do not help a business identify the help that it will need in performing an office move. Relocation projects require a lot of help from a lot of people and the estimates of staffing needs are often low.

Checklists do not provide samples of items typically required in a relocation project, such that a proper budget can be prepared and managed.

Checklists do not offer suggestions for contingency planning. Checklists will only list the activity one time. Completing an activity may require identifying that same activity more than once throughout the relocation process.

### SUMMARY OF THE INVENTION

The present invention is directed to a system and method for conducting and managing an office move. The inventive method can be implemented by hand, such as in a hard copy format, but is preferably implemented through a computer program that is internet accessible. The computer program is preferably accessed from the internet. Various components of the program (e.g., templates) can be downloaded and saved to a diskette or to the computer's hard drive. The method comprises at least a novel minimum of the following steps: selecting a project start date on a calendar time line to begin the completion of various tasks and activities associated with an office move; obtaining the anticipated date of the office move; identifying tasks and activities to be competed at particular times with respect to the date of the office move; assigning a person responsible and due dates to the predefined tasks and activities; identifying the internal processes required to complete the tasks and activities; prioritizing the tasks; customizing activities; providing a schedule of dates by which the tasks and activities should be completed, based on the anticipated date of the move and the prioritization of the tasks and activities; for a task, providing a list of decisions to be made in order to complete the task; for a task, providing a template to assist in the performance of the task; tracking the performance and completion of the tasks and activities; providing a person (user) with access to the schedule; providing the opportunity to limit access to the schedule; updating the tracking of the performance and completion of the tasks and activities; and storing the schedule and tracking information.

The method of the invention addresses a number of activities required for a successful office move, including, for example, those related to the physical move, tenant improvements, cabling, audio visual, signage, security and furniture.

To minimize the problem of miscommunication, the invention provides one site for move-related information. Activities, schedules, notes and responsibilities are clearly defined and easily accessible by approved staff and vendors. Because it is common for schedules to change on a daily basis, the method allows specific schedules to be downloaded, modified and uploaded to ensure that all move team members (staff and vendors) are kept current.

The invention includes a system for checks and balances. It allows a business to assign one administrator to authorize the purchase of the program and one project manager with the authority to make entries and revisions to the program. All other staff and vendors have read-only access. The project manager can easily manage the project by assigning staff and vendors to specific activities and completion dates. Activities can be prioritized on a daily or weekly basis. The calendar function allows the tracking of individual progress on a daily or weekly basis. Once a date is entered, a colored activity due date icon will appear on the calendar page indicating the due date of an activity. The project summary provides a one-page overview of the entire relocation process and provides a one-page overview of completed vs. outstanding tasks and displays an activity due date range for each task.

Important details are not overlooked. The invention provides over 400 predefined activities involved in an office move. Activities can be performed on a weekly basis or assigned a completion date. Templates provide examples, sample formats, questions to ask and items to consider.

Internal purchasing needs are not overlooked. The invention requires a business to identify the steps and time associated with the procurement of products and services.

The invention prevents important decisions from being neglected. It identifies and automatically prioritizes the activities that need to be addressed early on in the project due to the impact on the construction schedule (e.g. electrical requirements, dedicated telephone lines, shelving permits, etc.). The invention also allows the user to change dates and priorities.

The invention provides the opportunity to detail the vendors' scope of work. It contains a sample mover scope of work that can be modified to meet the user's specific requirements. It also identifies questions to ask and items to consider including work to be performed by other vendors. Similar templates are provided for other vendors including security, furniture and signage.

The invention minimizes the risk of the assumption that someone else is handling it. Critical path activities are identified, and persons responsible for each activity can be specified, eliminating assumptions. This is critical because certain activities may affect occupancy. Examples of these activities include the timely ordering and installation of dedicated telephone lines for testing and monitoring of fire/life safety services, executing required monitoring and maintenance agreements and obtaining elevator permits.

The invention helps estimate the staff needed to assist with the relocation by showing the entire relocation process. The invention identifies all activities required on a weekly or monthly basis. It also helps to estimate when staff and vendor needs are the greatest on a weekly basis. The calendar will allow the user to view the activities due on a daily basis.

The invention provides examples of items commonly used in an office relocation, such that detailed, accurate, office and construction budgets can be prepared and constantly managed throughout the move.

The invention assists with planning and documentation. Tasks provide a comprehensive audit trail of key activities and the names of the persons responsible for completing the activities. Additional information can be tracked and stored using an internal note pad for all activities. Templates provide multiple contingency examples.

### DETAILED DESCRIPTION OF THE DRAWINGS

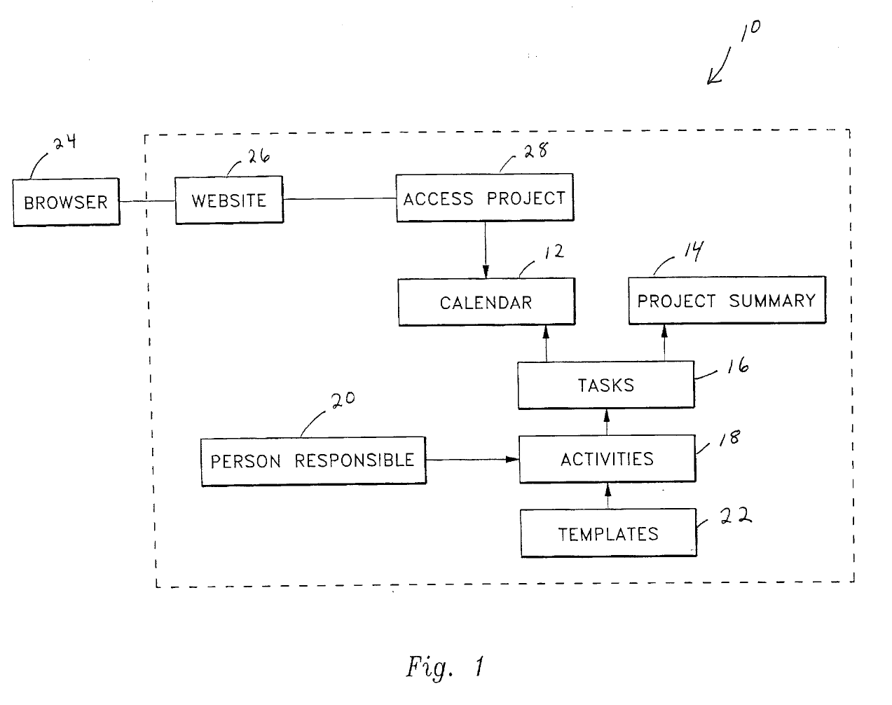

FIG. 1 is a block diagram which shows the inventive system and method being accessed from the internet.

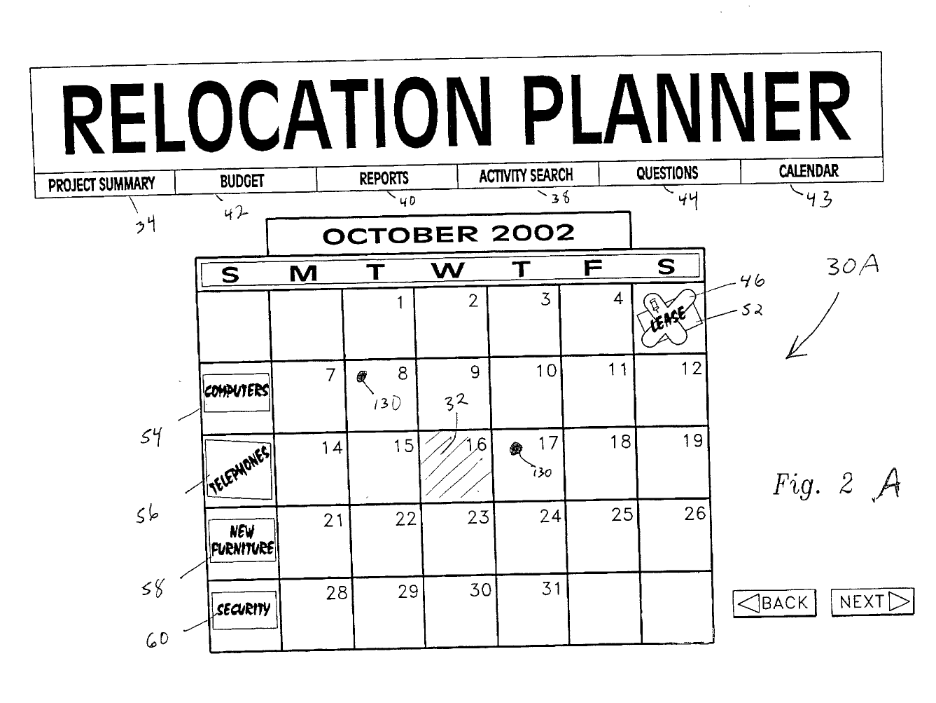

FIG. 2A is a web page as it might appear on a computer screen showing a calendar month having task icons and activity due date icon 130 distributed thereon.

FIG. 2B is a web page as it might appear on a computer screen showing a calendar month previous to the month shown in FIG. 2A having task icons and activity due date icon 130 distributed thereon.

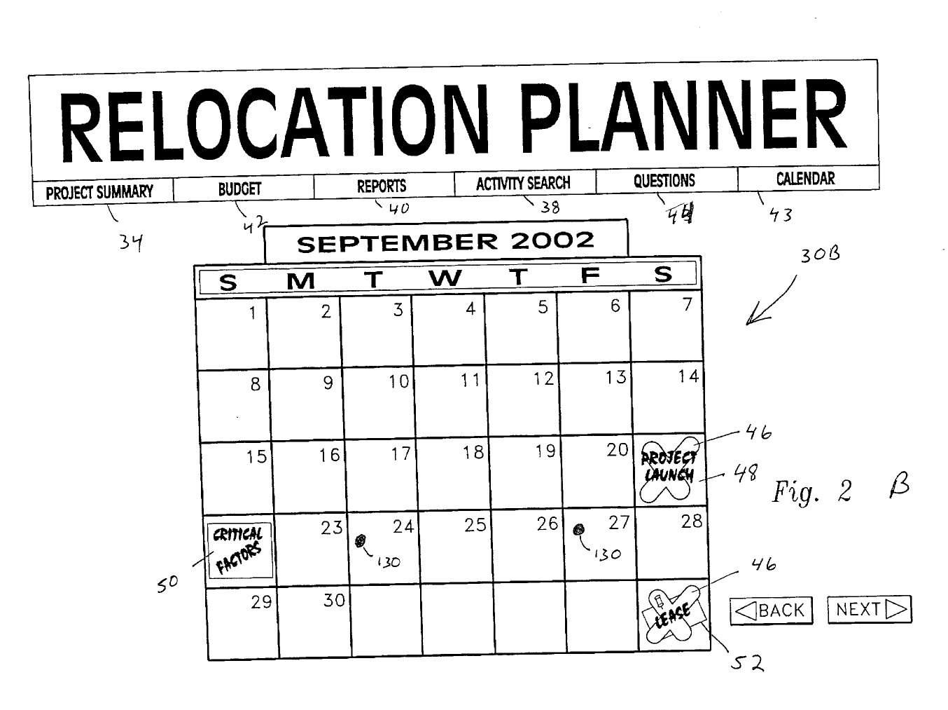

FIG. 3 is a web page as it might appear on a computer screen listing a summary of forty task icons corresponding to forty tasks which comprise the inventive method.

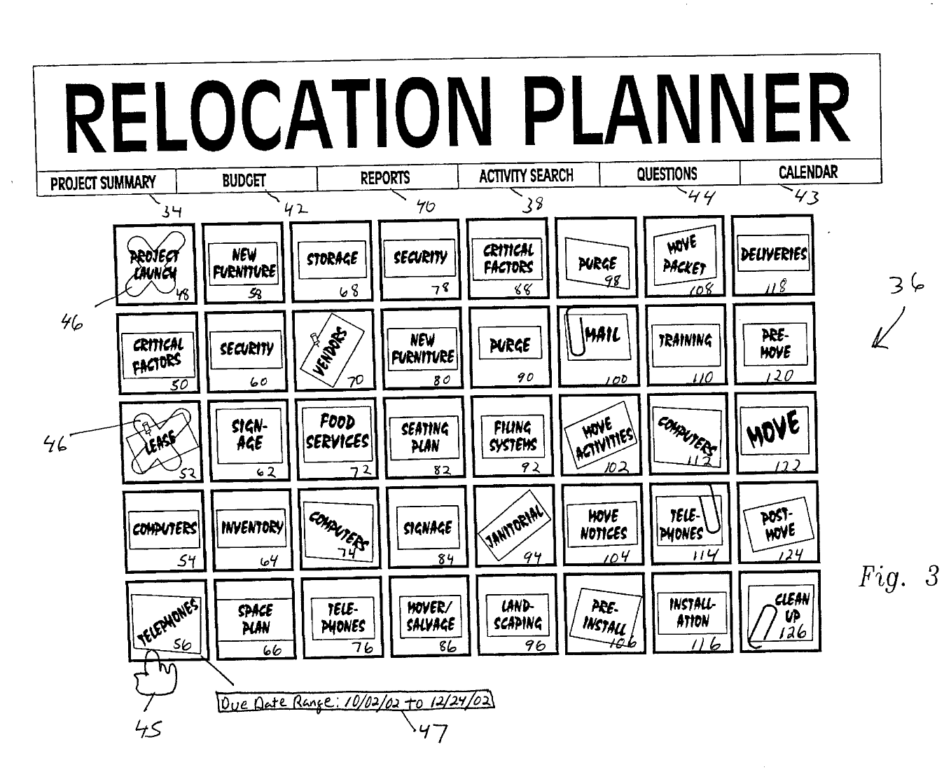

FIG. 4A is a partial web page as it might appear on a computer screen upon clicking on the “project launch” task icon.

FIG. 4B is the remainder of the web page shown in FIG. 4A.

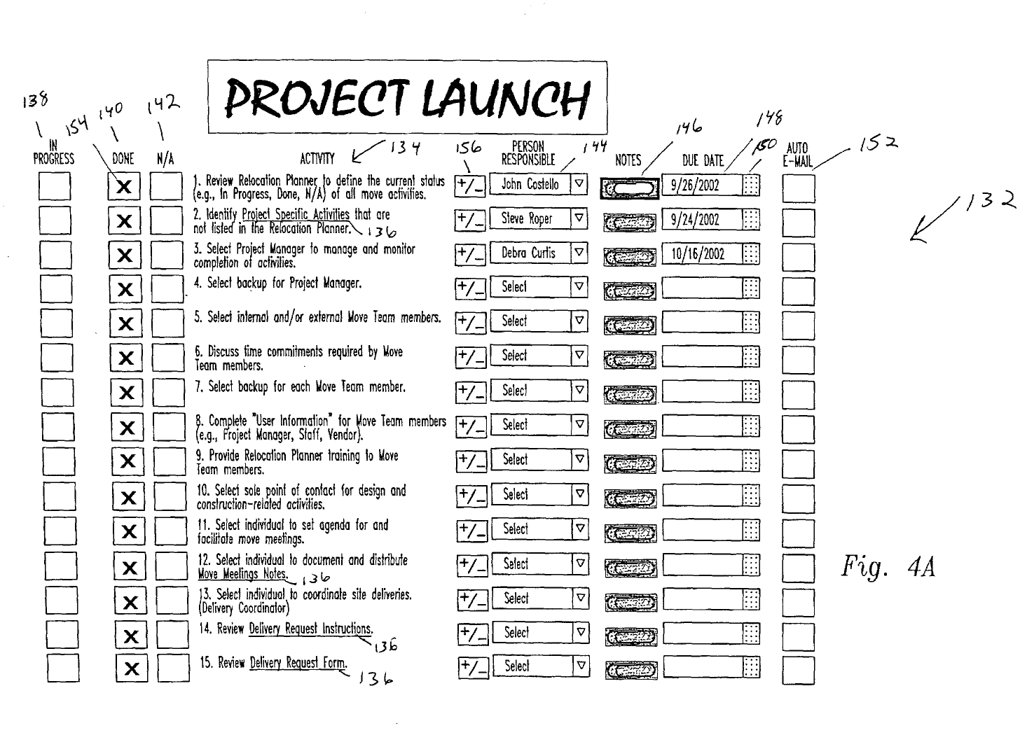

FIG. 5 is a web page as it might appear on a computer screen upon clicking on the “+/−” icon of FIG. 4.

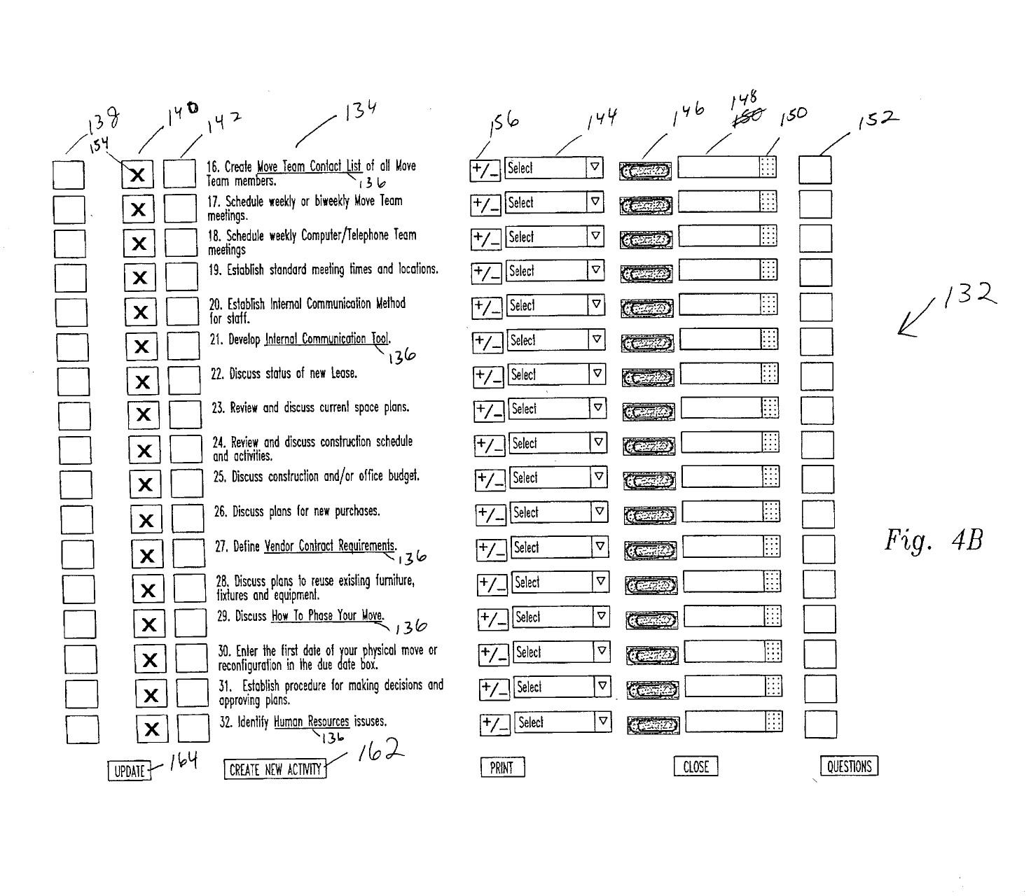

FIG. 6 is a web page as it might appear on a computer screen upon clicking on a template link of FIG. 4, this web page displaying an exemplary Microsoft Excel form.

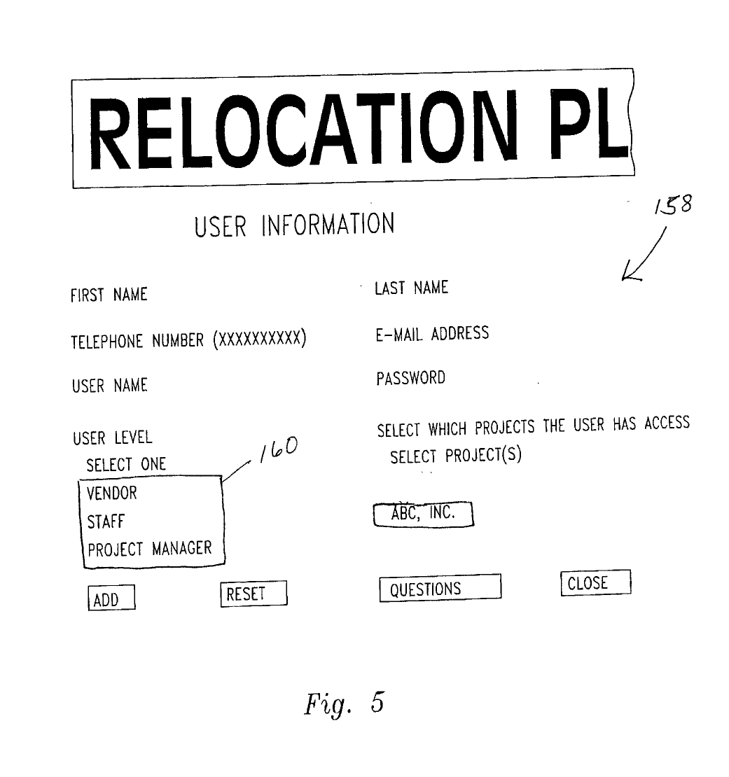

FIG. 7 is a web page as it might appear on a computer screen upon clicking on a template link of FIG. 4, this web page displaying an exemplary Microsoft Word document.

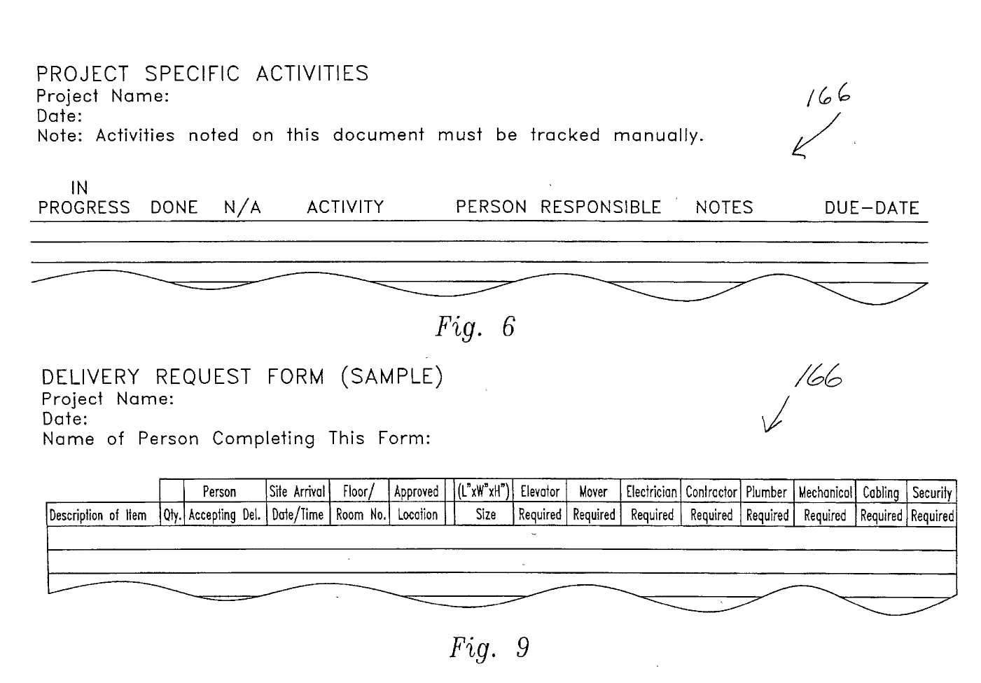

FIG. 8 is a web page as it might appear on a computer screen upon clicking on a template link of FIG. 4, this web page displaying an exemplary Microsoft Word document.

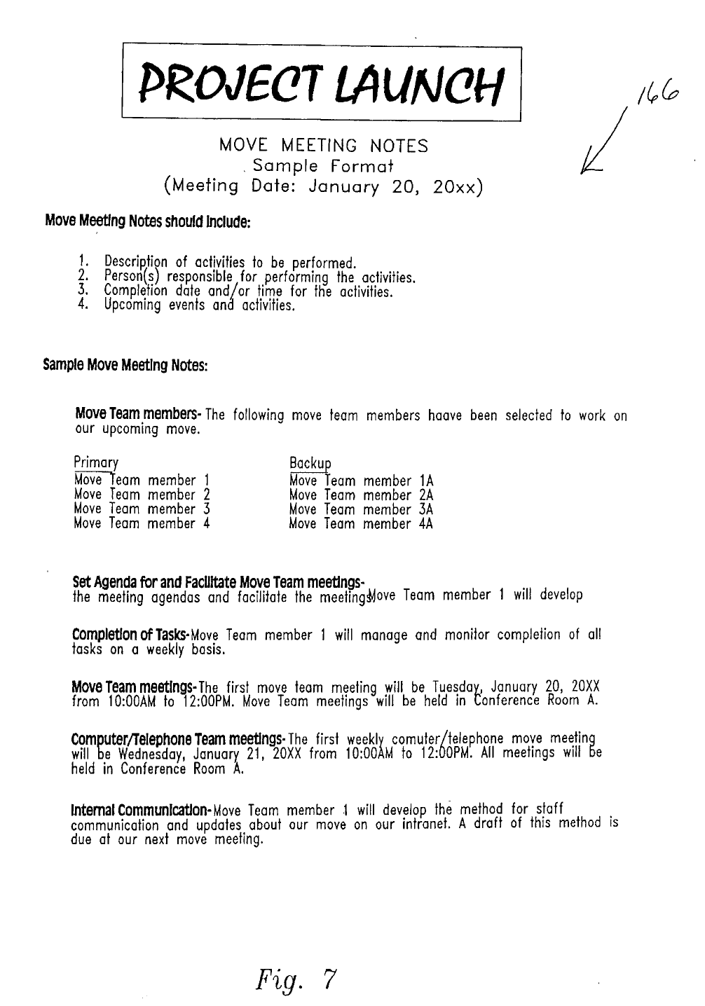

FIG. 9 is a web page as it might appear on a computer screen upon clicking on a template link of FIG. 4, this web page displaying an exemplary Microsoft Excel form.

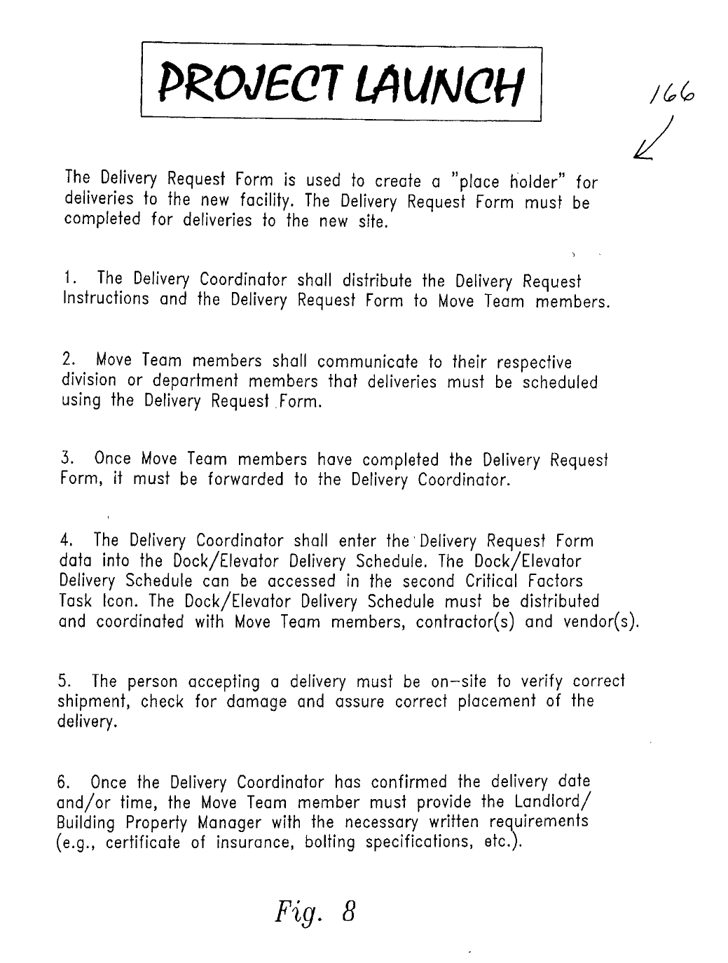

FIG. 10 is a web page as it might appear on a computer screen upon clicking on a template link of FIG. 4, this web page displaying an exemplary text document.

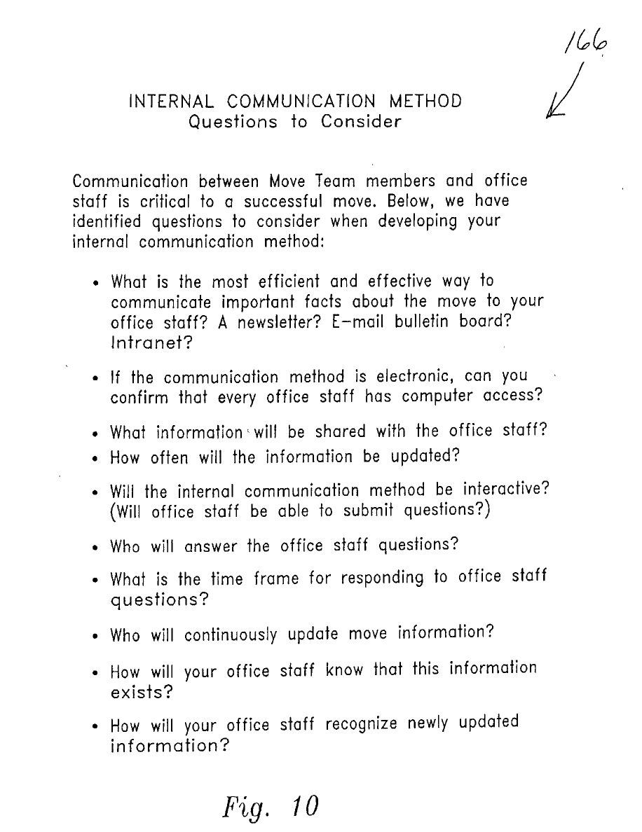

FIG. 11 is a web page as it might appear on a computer screen upon clicking on a template link of FIG. 4, this web page displaying an exemplary Adobe .pdf file showing a building floor plan.

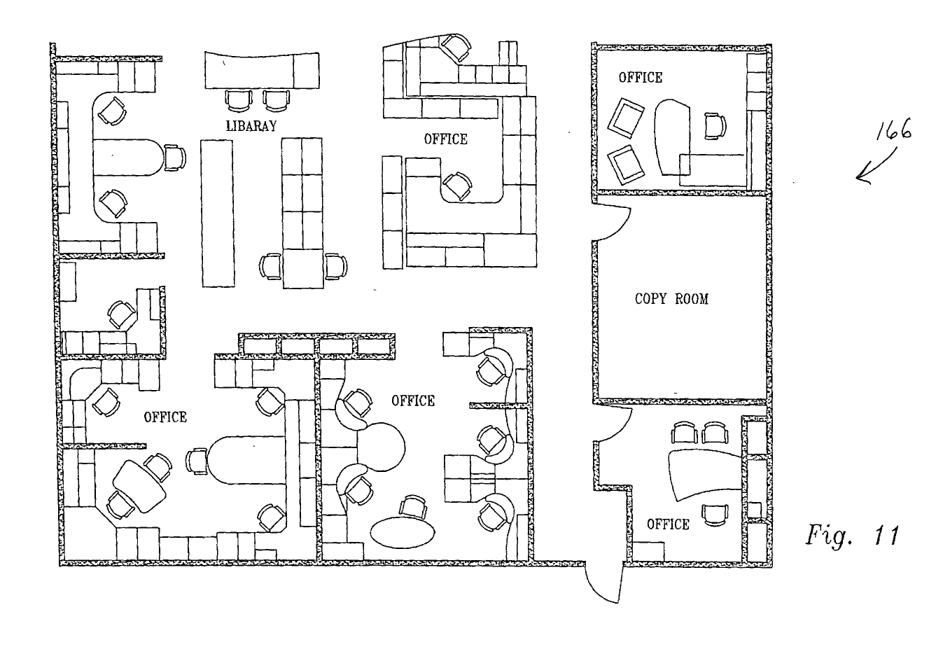

FIG. 12 is a web page as it might appear on a computer screen upon clicking on a template link from the “vendors” task web page, this web page displaying a Microsoft Excel form listing important vendors involved with a relocation project.

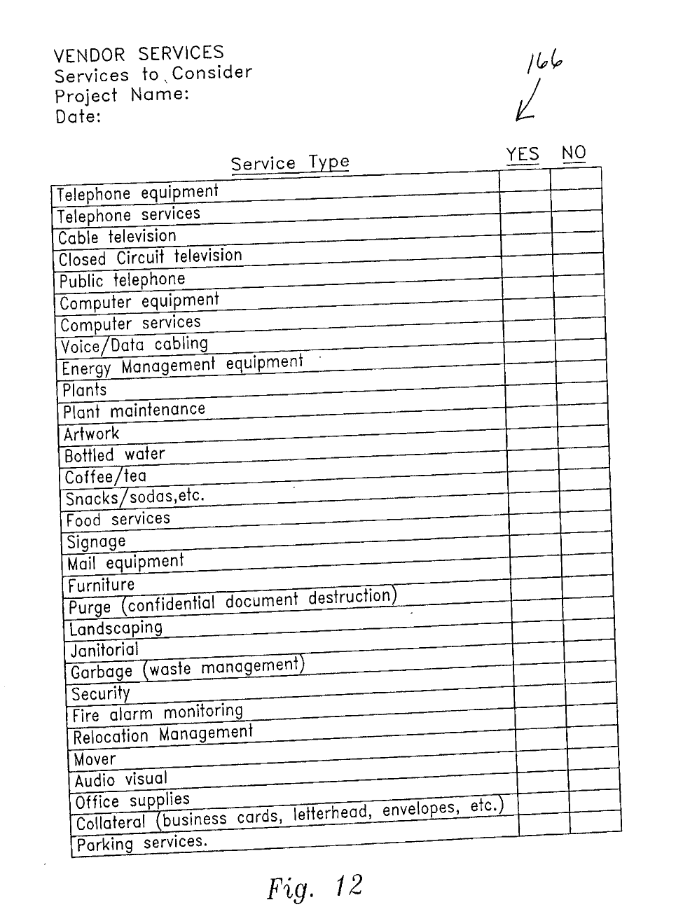

FIG. 13 is a web page as it might appear on a computer screen upon clicking on a template link from the “purge” task web page, this web page displaying a text document detailing guidelines for purging documents based upon the age and character of the document.

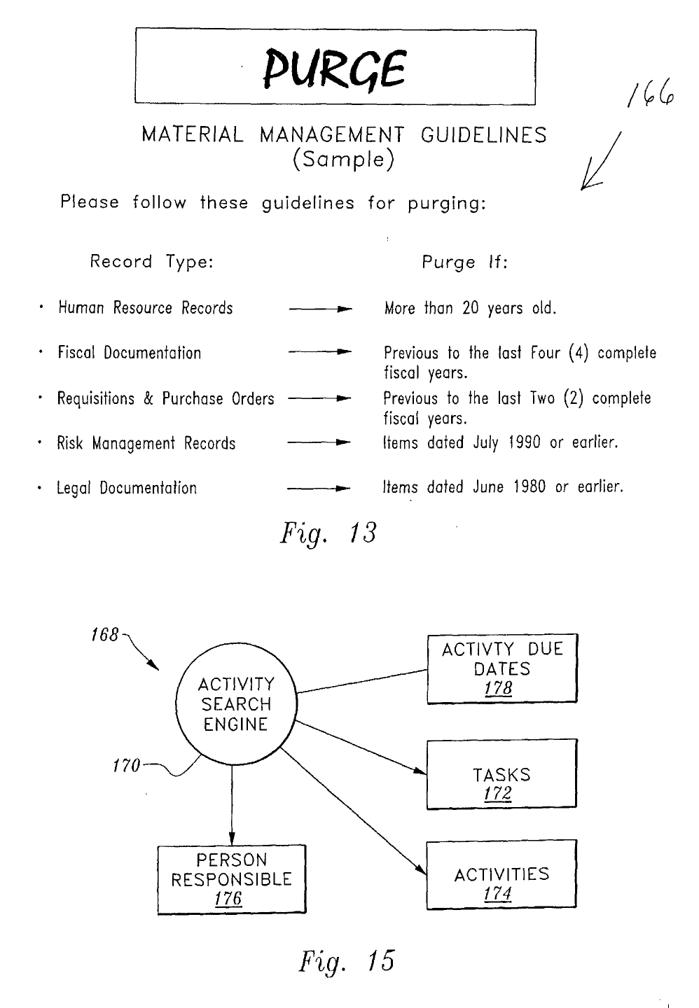

FIG. 14 is a web page as it might appear on a computer screen upon clicking on a template link from the “purge” task web page, this web page displaying a text document providing a schedule for purging documents in a high-rise building wherein the top floors of the building are purged first and the bottom floors are purged last.

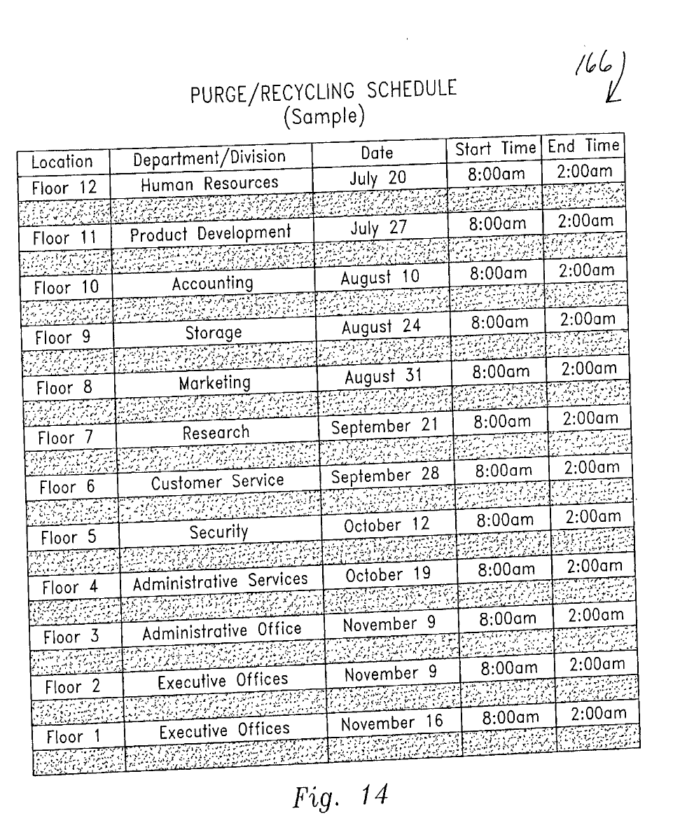

FIG. 15 is a block diagram which shows the search engine function of the inventive system and method.

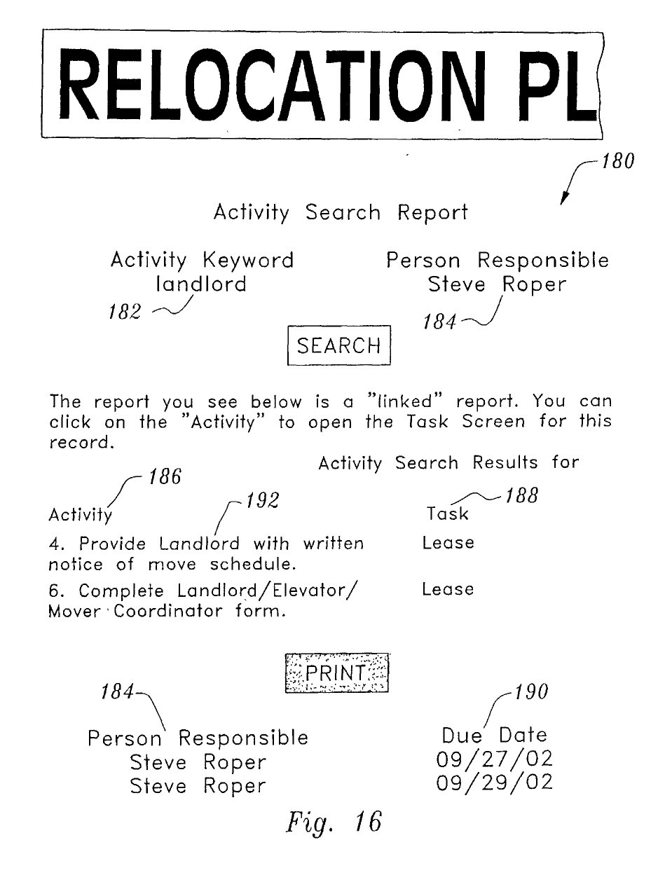

FIG. 16 is a web page as it might appear on a computer screen, which represents an activity report, which results when an activity keyword and a person responsible is entered into the search engine of FIG. 15.

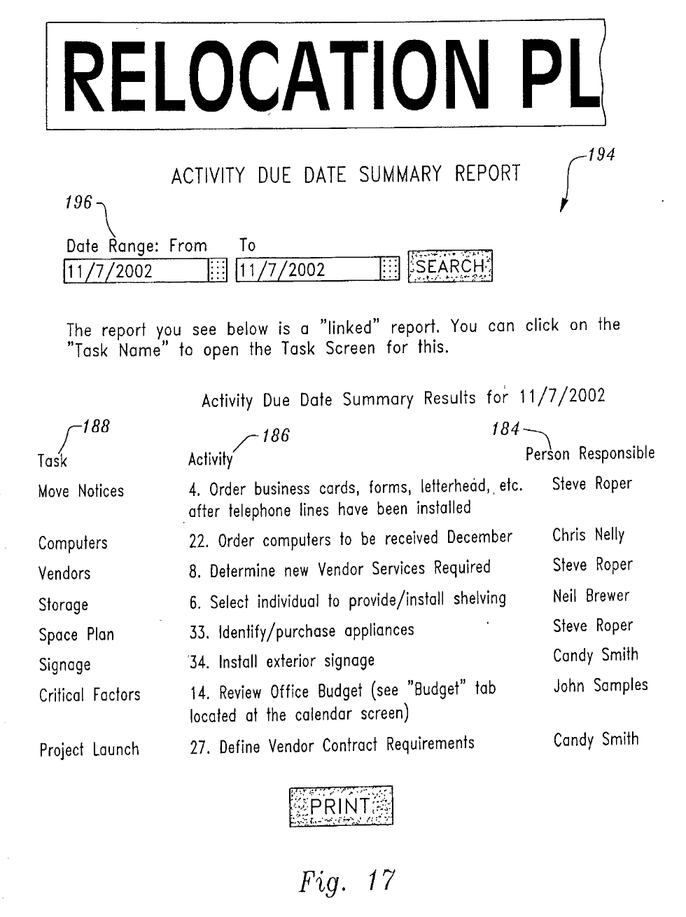

FIG. 17 is a web page as it might appear on a computer screen which represents an activity due date summary report, which results when a date range is entered into the search engine of FIG. 15.

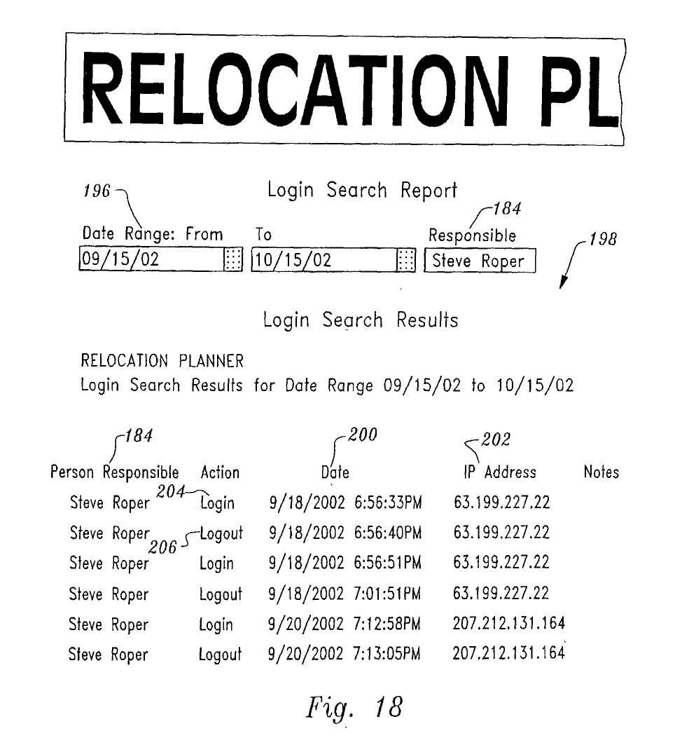

FIG. 18 is a web page as it might appear on a computer screen which represents a member login report, which results when a date range and a person responsible is entered into the search engine of FIG. 15.

### DETAILED DESCRIPTION OF THE PREFERRED EMBODIMENT

The preferred embodiment of the invention provides a system and method, accessible via the Internet, for the identification, prioritization and management of staff and activities involved in an office relocation project. Specific components of the invention include calendar, tasks, templates and project summary. This method can also be embodied in a computer program accessible via the internet or accessible via a computer readable medium such as diskette. Using the internet, for example, any person or company planning an office move could pay a fee to access the program and thereby use the program to plan an entire relocation project.

Using the internet, the inventive relocation method is executed through the creation, organization, storage, retrieval and display of digital information stored as bytes in a memory device, accessible through the internet, for interaction by a computer operated by a user such as a project manager, staff person or vendor involved with a relocation project. Because an explanation of the actual physical structure of the bytes within the memory is not particularly helpful to understanding the operation of the invention, it is necessary to characterize the stored data schematically and/or by functional diagrams and/or by labels, any or all of which may, and likely will, differ in appearance from how the actual data groups are stored in the memory device. Thus, it is not intended that the invention be limited by the particular labels or diagrammatic representations created to help explain the invention.

Referring to FIG. 1, the basic elements of the inventive system 10 include a calendar database 12 and a project summary database 14. The calendar and project summary databases store information on relocation tasks. Both the project summary and calendar databases are functionally related to a “tasks” database 16 which, in the preferred embodiment includes 40 tasks associated with a relocation project. The tasks database 16 is functionally related to an “activities” database 18 which includes over 400 individual activities associated with the 40 tasks in the tasks database. Each of the 40 tasks is associated with specific activities as will be further described below. The activities database 18 is functionally related to a “person responsible” database 20 which associates a person responsible for one or more activities comprising one or more tasks. The activities database 18 is also functionally related to a “templates” database 22 which provides templates associated with certain activities which provide examples, sample formats, lists, instructions, questions to ask and items to consider. The various databases described are functionally related through processing modules (not shown) and web interfaces to create an improved relocation planning system. The term “database” is used to indicate information identified with a particular label (e.g. calendar, project summary, tasks, activities, person responsible) which can be retrieved according to selectable criteria or by clicking on a web link or graphic icon.

As further shown in FIG. 1, the inventive method and system can be accessed through a user's computer using a browser 24 contacting the relocation method website 26. The website 26 includes a means for a user to securely access 28 a relocation project such as through a username and password, for example. The company's administrator must complete the project set up prior to the user accessing the program. During the project set up process, the user's company information and move date is entered. Upon obtaining access, the user is presented with a web page representation of the calendar 30A shown in FIG. 2A having the present date 32 and, which relates to that user's particular relocation project and access level, as will be further described herein. FIG. 2B shows a similar calendar 30B to FIG. 2A, representing the prior month (September) to that shown in FIG. 2A (October). From the web page showing the calendar 30A, 30B of either FIG. 2A or 2B, the user can click the “project summary” icon 34 and arrive at the project summary web page 36 shown in FIG. 3. Other clickable icons shown including icons for activity search 38, reports 40, budget 42, calendar 43 and questions 44 are also available. Some of these other icons are restricted access, depending on user access level. For example, a vendor preferably cannot get access to sensitive company budget information regarding the move. Some of these icons are discussed in further detail later herein.

The project summary 36 of FIG. 3 allows a user to have a single-page over view of the status of a relocation project. The project summary also includes a function which provides a due date range for all activities associated with a task which activates whenever a computer mouse icon contacts a task icon on the computer screen. As an example provided in FIG. 3, the “Telephones” task icon 56 has been contacted by the mouse icon 45 which activates a pop-up box 47 displaying a due date range from earliest to latest for all of the “Telephones” activities. The due date range helps a user to see at a glance whether the due date range is past, prior to, or contemporaneous with the present date.

Forty task icons comprise the project summary in the preferred embodiment. The task icons address the following moving-related issues:

Electrical requirements

Monitoring agreements

Maintenance agreements

Keying

Permits

Audio-visual equipment

Cabling

Site signage

Building signage

Interior signage

Computer equipment

Computer services

Printers

Telephone equipment

Telephone services

Security

Security agreements

Furniture

Refurbishing requirements

Vending services

Parking

Inventory

Artwork

Dock access

Elevator access

Building access

Janitorial

Salvage

Building protection

Building clean-up

Move Packets

Deliveries

Pre-move

Post-move

Training

Mail

Purge

Storage

Lease

Space plans

Purchasing

Seating plans

Filing systems

Move notices

Pre-install

Installation

Move activities

Vendors

Food services

Facility access

The invention identifies activities for various people involved in a move, including:

Move team members

Staff

Cabling vendor

Landlord

General contractor

Architect

Space planner

Electrical engineer

Mechanical engineer

Property manager

Move vendor

Furniture vendor

Furniture installer

Real estate broker

Audio-visual vendor

Referring again to FIG. 2B, a check mark, such as the red “X” 46 shown on the “project launch” and “lease” task icons 48, 52 signify that these tasks have been completed. The task icons on the project summary 36 are arranged in a logical order of completion shown in the direction of the arrows. The left side of the project summary signifies the tasks to be completed at the earliest dates in the relocation project, while the right side of the project summary signifies the tasks to be completed at later dates. An “X” will appear on all completed task icons. Also, some tasks such as “telephones” 56, 114 or “signage” 62, 84 appear twice or more, however the activities associated with these tasks are different at different phases in the move. For example, for “signage” it is best to search for signage vendors early in the first phase, while in the second, later phase, activities involving actually removing signs from the old location is more appropriate from a timing perspective.

The invention operates on the calendar time line, 30A, 30B shown in FIGS. 2A, 2B which is accessed by clicking the calendar icon on the project summary web page 36 shown in FIG. 3 and already described. The project shown in the calendar web pages of FIGS. 2A, 2B was launched in September of 2002. The same task icons 48-126 from the project summary 36 are distributed on the calendar 30A, 3B in the same order. The calendar may be spread out over one or a number of months, depending on the urgency of the move date. A realistic move pace is to place one task icon on each consecutive week as shown. For the forty task icons shown on the project summary 36 of FIG. 3, the move pace would correspondingly take about forty weeks. Completed tasks are similarly designated with a check mark (“X”) in the manner previously described. However, to clearly separate the completed task icons from the uncompleted, the completed tasks are shifted to the right side of the monthly calendar and the uncompleted tasks remain on the left side. The left side indicates a desired task completion date while the right side indicates actual task completion. In FIG. 2B, the “project launch” and “lease” icons 48, 52 are checked and shifted to the right side of the calendar 30B, while the “critical factors” icon 50 is unchecked and remains on the left side of the calendar. Also, in FIG. 2B, which represents the month of September, in which the move project was launched, the last completed task was the “lease” task icon 52 and this completed task is carried over into the first week of October shown in FIG. 2A and shifted to the right side of the calendar 30A to carryover its completed status. Had the lease task not been completed, it would have shown up in the first week of FIG. 2A on the left side of the calendar 30A. This carryover allows the user to recall quickly what the last task from the prior month involved, and whether it was completed, so that continuity between past tasks with future tasks is maintained. Also in FIG. 2A, the present date 32, here shown as the 16^{th} of October is designated by a different color from the other dates. For example, the 16^{th} could be colored in a conspicuous red so that at a glance someone viewing the calendar 30A would be able to tell whether scheduled tasks have been completed by their allotted weeks. In FIG. 2A, the present date of the 16^{th} has surpassed the uncompleted “computers” and “telephones” task icons. This informs a user looking at the calendar of FIG. 2A that the move project may be falling behind schedule, at least with regard to these uncompleted tasks.

Still referring to FIG. 2A, staff and vendor calendars will only show activities assigned to the individual user. Only the administrator and project manager calendar will show all activities due on their calendars.

Also in FIG. 2A are certain dates having colored circular activity due date icons 130. The activity due date icons correspond to activities due on that date. Upon clicking on the icon 130, a web page summary of activities due on that date appears. The calendar month with activity due date icons differs depending on whether a staff person, vendor, project manager or administrator is using the program. An individual staff person or vendor; upon logging into the program and pulling up the calendar will be presented with a calendar showing icons 130 pertaining to that individual only. This allows the individual, be it staff or vendor to know, at a glance, the activities to which he/she is assigned, and the corresponding due dates for completing the activities. Alternatively, a person having project manager or administrator access would be presented with a calendar month web page having icons 130 for every date on which an activity is due for all parties (staff, vendor, etc.) who are working on the project so that all activities performed by all parties for the entire month can be monitored by the project manager or administrator. If certain activities are not being completed, a project manager can contact the staff person charged with completing the activity, for example, and find out why the activity is not completed. Uncompleted activities can easily be seen by the staff person or project manager, as the red colored date will surpass the uncompleted activity due date icon 130 as was described above for uncompleted task icons.

Upon entering a move date, the invention will automatically distribute task icons 48-126 onto the monthly calendars. The dates on which the icons are distributed indicate desired task completion dates in relation to the move date. If the move date changes, a pop-up reminder will prompt them the user to review and modify all activities. Previously completed tasks potentially affected by the new move date will not be automatically identified and will require the project manager to review and update activities based on the new move date. The task icons define relocation activities and store information related to the activity provided by the end user. Clicking on the task icons reveal the activities which must be completed to mark the tasks as being completed (checked) on the calendars. Templates associated with certain activities provide examples, sample formats, lists, instructions, questions to ask, and items to consider. The following describes in detail the activities and templates associated with each of the forty tasks comprising the moving method in proper order of completion. For office moves with shorter timeframes, the user can input a future move to remove icons from the calendar.

Project Launch

FIGS. 4A and 4B illustrate a web page 132 which would appear from clicking on the “project launch” task icon 48 on either the calendar or project summary web pages. The calendar month bearing the project launch icon is the start date for the relocation project. FIGS. 4 and 4B represent the project launch activities 134 and template links 136 associated therewith. The activities 134 comprising the project launch task 48 are numbered from 1-32. Activity numbers 2, 12, 14, 15, 16, 20, 21, 27, 29, 32 have underlined links 136 which represent templates. To the left of the listed activities are three check boxes labeled “in progress,” 138 “done,” 140 and “N/A” (not applicable) 142, which signify the completion status of the corresponding activity 134. To the right of the listed activities are boxes 144 for selecting a person responsible for completing the assigned activity, a notes icon 146 (e.g. a paperclip) which allows the person responsible to draft notes regarding the activity, an activity due date box 148 with a pop-up calendar 150 and an auto e-mail 152 to remind staff and vendors of their assigned activities and due dates.

If an activity has passed it's scheduled due date, the activity due date icon 130 will still appear on the calendar and the user will not get an “X” on the task icon. Once the activity is “done” or “N/A”, the activity due date icon 130 will disappear. The text describing the activity will also disappear from the activity due date summary report, described further herein.

As seen in FIGS. 4A and 4B, the “done” boxes 140 are checked 154 for each activity. If the “done” or “N/A” boxes are all checked, the computer program places a check mark 146 on the task icon 48-126 on the calendar 30A, 30B and project summary 36 as previously described. If any of the boxes are checked “in progress” 138 or no boxes are checked, the task icons 48-126 remain unchecked on the calendar and project summary.

Regarding the “notes” paperclip icon, this icon 146 will turn red if a note has been recorded and silver where no note has been recorded. This allows users to save time by seeing at a glance which activities have important notes to be reviewed.

Next to the “person responsible” box 144 is a “+/−” icon 156 which, when clicked, opens up into a user information 158 form of the type shown in FIG. 5. Only an administrator and project manager having high access can input information in this form. The form has various name, phone number, password and address fields to be able to identify a user. The form also has a box 160 to allow a user to be classified as a vendor, staff person or project manager. The classification allows for the management of the completion of activities while allowing move team members “read only” access. For example, an administrator and a project manager can be vested with full access to manage any activity in the inventive method, while a staff member or vendor is granted “read only” access to be able to view the progress of the move without being able to alter the scheduling of the tasks and activities. More specifically, from FIGS. 4A and 4B, a staff person may only be able to access the “notes” function 146 or designate a task as being only “in progress,” 138 while the administrator and a project manager may be the only people who have access to, and can alter, the other boxes and functions shown in FIGS. 4A and 4B. The administrator and project manager are the only people who can designate a task as being completed, for example. Additionally, vendors or others can be prevented from accessing sensitive information regarding the move, such as budget information.

Referring again to FIG. 4B, a number of icons at the bottom require explanation. The “update” icon 164 allows for the information on the form to be updated in the system after it has been changed. For example, if only one activity remained to be completed and was completed in due course, the administrator and project manager could mark the check box “done” for that activity, and update the system. The program would then indicate the task icons as check marked, where previously, prior to the update, they would have been shown as unchecked. Alternatively, the program is designed to update activities by selecting the update button. The “create new activity” icon 162 allows for an administrator and project manager having high access to add relevant activities and thereby custom tailor the activity list to a specific relocation project. The “create new activity” icon not only allows for a new activity to be created, but also allows associated template links to be added, these links being described further below. The “print,” “close” and “questions” icons are self-explanatory and well known in the art.

A number of templates 166 are associated with specific activities as part of the relocation planning method herein described. FIGS. 4A and 4B, designate these templates with underlined links 136 associated with specific activities. Many of the templates are Microsoft Excel forms which help a user organize the activity, while other templates are Microsoft Word text files which provide questions to consider which are specific to an activity or else are activity-specific formats, instructions and summaries. Furthermore, the links 136 can open into Adobe .pdf files which might provide a layout of the new building being relocated to, for example.

FIG. 6 is exemplary of a Microsoft Excel form template 166 associated with activity “2” of FIG. 4 which allows a user to identify project specific activities which are not listed in the relocation planning method. This form allows a user to manually add in other activities specific to a particular relocation planning project. The categories on this form are self explanatory.

FIG. 7 is exemplary of a Microsoft Word notes template 166 associated with activity “12” of FIG. 4A, which relates to organizing a moving meeting. The method provides such notes as sample formats to organize various activities, thereby saving time and labor involved in organizing a move.

FIG. 8 is exemplary of a Microsoft Word instructions template 166 associated with activity “14” of FIG. 4A, which allows a user to organize a delivery activity. Someone who has never been involved with arranging the delivery of items involved in a move will be able to follow these instructions and perform them accordingly.

FIG. 9 is exemplary of a Microsoft Excel form template 166 associated with activity “15” of FIG. 4A, which allows a user to properly organize a delivery activity. Various categories relate to the item delivered and allow important decisions related thereto to be made. For example, if a computer was the item delivered, it might require a proper cabling hookup and security if it has sensitive matter stored on its hard drive.

FIG. 10 is exemplary of a Microsoft Word template 166 listing questions to consider which are associated with activity 20 of FIG. 4B, which allows a user to have a checklist of questions related to an activity so that no details relating to the activity are overlooked, and so decisions regarding the activity can be made. Here, in FIG. 10, the questions relate to the activity of planning internal communication among move team members.

The project launch task 48 described in detail in the previous figures and written description is but one of 40 tasks comprising the inventive relocation method. The 40 tasks, include over 400 activities associated with them, in the preferred embodiment. The other tasks are all organized in a similar manner described for the project launch task, with FIGS. 4A and 4B being exemplary of the web page structure adopted for all of the tasks. Upon clicking on a task icon 50-126, a similar web page as in FIGS. 4A and 4B emerges for each. The sole important difference between tasks is the activities associated therewith, otherwise the same categories and functions described for the project launch task web page 132 apply. The templates for the other tasks are primarily forms, questions, notes, instructions, sample formats, etc., as previously described for the project launch task 48, however some templates may be of special interest and bear further disclosure as noted below.

The following listing of the remaining tasks (shown in FIG. 3) focuses upon the novel activities comprising each task and also focuses on any templates worthy of special mention:

Critical Factors I

Items such as telephone hookups, new furniture, utilities and the progress of construction at the new location are critical to a move and must be constantly monitored. The critical factors task is addressed in two phases 50, 88 in the inventive relocation method. A listing of the activities associated with the first critical factors task phase 50 include the following:

1. Identify Project Specific Activities that are not listed the Relocation Planner.

2. Identify work required to obtain an Occupancy Permit.

3. Define Electrical requirements

4. Identify required Dedicated Telephone Lines.

5. Identify existing lease agreements for furniture, fixtures and equipment (e.g., vending machines, copiers, plants, etc.).

6. Identify sole point of contact to manage future modifications to existing lease agreements.

7. Identify Union requirements.

8. Identify Health Department requirements.

9. Identify Certificate of Insurance requirements for vendors.

10. Identify additional insurance coverage required.

11. Identify parking requirements (e.g. electric vehicles, bike racks, ADA access).

12. Define a numbering/labeling scheme for offices and workstations to be used by Move Team members and vendors.

13. Review Construction Budget (see “Budget” tab located at the calendar screen).

14. Review Office Budget (see “Budget” tab located at the calendar screen).

Lease

Coordinating a move in accordance with the building lease terms is important. For example, if a move date has been set, it may fall short of the end of a lease agreement and penalties for early termination of the lease may apply; hence the lease needs to be examined for any terms which can negatively or positively impact the move. A listing of the activities associated with the lease task 52 include the following:

1. Identify Project Specific Activities that are not listed in the Relocation Planner.

2. Review existing Lease for modification requirements (e.g., cancel, extend, etc.).

3. Determine the Last Day you will physically occupy your current facility.

4. Provide Landlord with written notice of the move schedule.

5. Identify building protection requirements for current/new facilities.

6. Complete Landlord/Elevator/Mover Coordination form.

Computers I

It has been found that dividing up the computers tasks into three separate phases 54, 74, 112 results in the smoothest transition during a move. For example, during the first phase 54 it is prudent to perform such activities as identifying space for computers at a new location, whereas computer training may be best reserved for the later phases 74, 112 when people are most likely to remember and retain their new computer training. Hence the task icons would show three different “computers” icons 54, 74, 112 spaced out at various intervals along the calendar months and project summary. For the first computer task phase 54, a listing of activities associated therewith are as follows:

1. Develop budget for new computer equipment and services.

2. Identify Project Specific Activities that are not listed in the Relocation Planner.

3. Select sole point of contact for computer needs.

4. Select individual to document and communicate key decisions.

5. Identify milestones and critical dates for computer activities.

6. Confirm milestones and critical dates with contractor.

7. Coordinate vendor work schedules with contractor.

8. Confirm contractor milestones and critical dates for vendor.

9. Confirm location and size of the minimum point of entry (MPOE).

10. Determine vendor responsible to run data cabling from street to the minimum point of entry (MPOE).

11. Determine vendor responsible to run data cabling from minimum point of entry (MPOE) to computer rooms/closets.

12. Determine vendor responsible to run data cabling from computer rooms/closets to data jack locations.

13. Define exterior and interior conduit and/or sleeve requirements.

14. Confirm location and size of computer rooms/closets.

15. Identify existing computer equipment (e.g., racks, servers, printers, copiers, etc.).

16. Identify existing computer services (e.g., T-1, DSL, etc.).

17. Identify existing computer equipment to be reused.

18. Develop an equipment plan (to scale) identifying existing computer equipment to be reused.

19. Review Computer Equipment Plan .pdf file.

20. Define new computer equipment requirements (including audio visual).

21. Define new computer service requirements (including computer cabling).

22. Revise equipment plan to include new and existing computer equipment.

23. Define plan for future expansion after the move (e.g., additions, upgrades).

24. Define data jack configuration for computers (and telephones).

25. Develop a schematic identifying the location and quantity of computer (and telephone) lines.

26. Identify data jack requirements for speciality functions (e.g., energy management controls, etc.).

27. Define computer cabling color requirements.

28. Define process for cancellation of existing computer services.

29. Define plywood backboard requirements for computer rooms/closets.

30. Define raised flooring requirements for computer rooms/closets.

31. Define electrical requirements (e.g., floor, wall, ceiling) for computer rooms/closets.

32. Define lighting requirements for computer rooms/closets.

33. Define mechanical (e.g., air conditioning) requirements for computer rooms/closets.

34. Define security requirements for computer rooms/closets.

35. Define fire suppression system requirements for computer rooms/closets.

36. Define lead time requirements for new computer equipment and services.

37. Schedule pre-bid meeting with computer equipment and service vendors.

38. Identify changes to be made to existing computer equipment (e.g., install Ethernet cards, etc.).

39. Determine when changes to existing equipment will be made.

40. Define who will make changes to existing computer equipment.

41. Establish Equipment Disconnect/Reconnect Procedures.

42. Review Equipment Disconnect/Reconnect Scope of Work (see Mover/Salvage Task icon).

43. Identify roof-mounted equipment issues.

A template 166 associated with task “19”, above is a .pdf file of the layout of the new location. A sample of such a .pdf file is shown in FIG. 11. This file is useful for allowing staff, vendors and others directly associated with moving the computer equipment to have a building layout for planning the move. The same .pdf file could be useful as a template in any other task comprising the invention, such as planning the placement of furniture at the new location.

Telephones I

Like computers, the telephone portion of the inventive method is separated into three phases and the task icons 56, 76, 114 are correspondingly spaced at various intervals along the calendar months and project summary. For the first telephone task 56, a listing of activities associated therewith are as follows:

1. Develop budget for new telephone equipment and services.

2. Identify Project Specific Activities that are not listed in the Relocation Planner

3. Select sole point of contact for telephone needs.

4. Select individual to document and communicate key decisions.

5. Identify milestones and critical dates for telephone activities.

6. Confirm milestones and critical dates with contractor.

7. Coordinate vendor work schedules with contractor.

8. Confirm contractor milestones and critical dates for vendor.

9. Identify new telephone service provider.

10. Identify when telephone end user information will be due to telephone service provider.

11. Identify process to collect telephone end user information.

12. Define format for end user information (coordinate with telephone service provider).

13. Develop required telephone end user information.

14. Confirm location and size of the minimum point of entry (MPOE).

15. Determine vendor responsible to run telephone cabling from street to minimum point of entry (MPOE).

16. Determine vendor responsible to run telephone cabling from minimum point of entry (MPOE) to telephone rooms/closets.

17. Determine vendor responsible to run telephone cabling from telephone rooms/closets to telephone jack locations.

18. Define exterior and interior conduit and/or sleeve requirements.

19. Confirm location and size of telephone rooms/closets.

20. Identify existing telephone equipment (e.g., PBX, call accounting, music on hold, etc.).

21. Identify existing telephone services.

22. Identify existing telephone equipment to be reused.

23. Develop an equipment plan (to scale) identifying existing telephone equipment to be reused.

24. Review Telephone Equipment Plan .pdf file.

25. Define new telephone equipment requirements.

26. Define new telephone service requirements.

27. Determine the need for white noise.

28. Verify service area requirements for cellular telephones and pagers.

29. Revise equipment plan to include new and existing telephone equipment.

30. Define plan for future expansion after the move (e.g., additions, upgrades).

31. Define jack configuration (for telephones and computers).

32. Develop a schematic identifying the location and quantity of telephone, fax, (and computer) lines.

33. Identify jack requirements for specialty functions (e.g., fire alarm monitoring, ATM, etc.).

34. Define telephone and jack color requirements.

35. Define process for cancellation of existing telephone services.

36. Define plywood backboard requirements for telephone rooms/closets

37. Define raised flooring requirements for telephone rooms/closets.

38. Define electrical requirements (e.g., floor, wall, ceiling) for telephone rooms/closets.

39. Define lighting requirements for telephone rooms/closets.

40. Define mechanical (e.g., air conditioning) requirements for telephone rooms/closets.

41. Define security requirements for telephone rooms/closets.

42. Define fire suppression requirements for telephone rooms/closets.

43. Define lead time requirements for new telephone equipment and services.

44. Schedule pre-bid meeting with equipment and service vendors

45. Identify changes to be made to existing telephone equipment (e.g., add voicemail module).

46. Determine when changes to existing telephone equipment will be made.

47. Determine who will make changes to existing telephone equipment.

48. Identify telephone programming requirements (e.g., number of rings before voicemail).

49. Identify vendor to program telephone system.

50. Specify functions and features for workstation telephones.

51. Specify functions and features for hard wall offices, cafeteria and quiet rooms.

52. Specify functions and features for board rooms and conference rooms.

53. Identify telephone types (e.g., desk versus wall mounted).

54. Determine how to detail telephone handsets.

55. Select vendor to detail telephone handsets.

56. Schedule when and where telephone detailing will be performed.

57. Establish Telephone Disconnect/Reconnect Procedures.

58. Identify roof-mounted equipment issues.

59. Identify radio equipment requirements (base station/console).

Furniture I

The furniture tasks 58, 80 are also phased along the moving time line in the inventive method. For the first furniture task 58, a listing of the activities associated therewith are as follows:

1. Develop budget for new furniture.

2. Identify Project Specific Activities that are not listed in the Relocation Planner.

3. Select sole point of contact for new furniture needs.

4. Select individual to document and communicate key decisions.

5. Identify milestones and critical dates for new furniture activities.

6. Confirm milestones and critical dates with contractor.

7. Coordinate vendor work schedules with contractor

8. Confirm contractor milestones and critical dates for vendor.

9. Review proposed color scheme of new facility with interior designer or architect.

10. Identify existing furniture (e.g., desks, seating, files, systems furniture, etc.) to be reused.

11. Review location of heavy files, libraries, etc. with architect/engineer.

12. Develop a furniture plan (to scale) identifying existing furniture to be reused.

13. Review Existing Furniture Layout .pdf file.

14. Review Furniture Considerations.

15. Solicit requests for special accommodations (e.g., seating, furniture heights, etc.) from office staff.

16. Establish requirements for new office and workstation furniture.

17. Establish requirements for new conference room, cafeteria, lobby and specialty furniture.

18. Establish requirements for new seating.

19. Establish requirements for new filing systems.

20. Establish requirements for new whiteboard and presentation boards.

21. Revise furniture plan to include new and existing furniture.

22. Define plan for future expansion after the move (e.g., additions, upgrades).

23. Define voice and data furniture requirements.

24. Define electrical requirements.

25. Review furniture plan with architect for ADA compliance.

26. Identify conflicts between furniture and thermostats, fire extinguishers, telephones, etc

27. Schedule pre-bid meeting with furniture vendors.

28. Develop furniture bid.

Security I

The security tasks 60, 68 are phased along the moving time line in the inventive method. For the first security task 60, a listing of the activities associated therewith are as follows:

1. Develop budget for new security system.

2. Identify Project Specific Activities that are not listed in the Relocation Planner.

3. Select sole point of contact for security needs.

4. Select individual to document and communicate key decisions.

5. Develop Disaster Recovery Plan.

6. Schedule implementation of the Disaster Recovery Plan.

7. Identify milestones and critical dates for security activities.

8. Confirm milestones and critical dates with contractor.

9. Coordinate vendor work schedules with contractor.

10. Review existing security system Lease and/or Monitoring Service Agreements.

11. Define existing security system equipment.

12. Identify existing security system equipment to be reused.

13. Review Security System considerations.

14. Determine new security system requirements.

15. Develop plan indicating the location of interior/exterior security equipment.

16. Schedule pre-bid meeting with security vendors.

17. Develop security system bid.

18. Review Security Plan .pdf file.

Signage I

The signage tasks 62, 68 are phased along the moving time line of the inventive method. For the first signage task 62, a listing of the activities associated therewith are as follows:

1. Develop budget for signage.

2. Identify Project Specific Activities that are not listed in the Relocation Planner.

3. Identify sole point of contact for signage needs.

4. Select individual to document and communicate key decisions.

5. Identify milestones and critical dates for new signage needs (include time for sign mockups).

6. Coordinate milestones and critical dates with contractor.

7. Coordinate vendor work schedules with contractor.

8. Identify signage required for Occupancy Permit—contractor provided.

9. Identify signage required for Occupancy Permit—tenant provided.

10. Define signage permit requirements.

11. Define evacuation plan approval requirements.

12. Review corporate signage guidelines and/or signage style requirements.

13. Review proposed color scheme of new facility with interior designer or architect.

14. Establish building standard signage requirements (defined by Landlord/Building Property Manager).

15. Identify existing signage to be reused.

16. Identify exterior facility signage requirements (e.g., monument signs, etc.).

17. Identify exterior building signage requirements (e.g., logo, address, etc.).

18. Identify access panels required for exterior building signage (coordinate with contractor).

19. Identify interior signage requirements (e.g., evacuation, directional, departmental, nameplates, etc.).

20. Define exterior and interior conduit and/or sleeve requirements.

21. Identify electrical required for interior/exterior signage.

22. Identify off-site signage requirements (e.g., freeway signage).

23. Identify parking lot signage requirements.

24. Identify special signage requirements (e.g., no loitering, reserved parking, etc.).

25. Define sign materials, colors, finishes, etc.

26. Develop schematic plan identifying location of signage.

27. Review Signage Location .pdf file.

28. Define mounting heights for signage.

29. Confirm ADA signage requirements.

30. Define mounting requirements for different surfaces (e.g., glass, wallcovering, systems furniture, etc.).

31. Define backing requirements for signage mounted on glass.

32. Develop signage bid.

33. Schedule pre-bid meeting with sign vendors.

Inventory

Maintaining a proper inventory of furniture and equipment during the move insures that all items will reach the new location. An inventory system also allows tracking of furniture and equipment should it become lost or stolen during the move. For the inventory task 64, a listing of the activities associated therewith are as follows:

1. Identify Project Specific Activities that are not listed in the Relocation Planner.

2. Review Furniture & Equipment Inventory Guidelines.

3. Complete Furniture & Equipment Inventory form.

4. Identify and label existing furniture and equipment to be reused.

5. Identify and label exisiting furniture and equipment to be salvaged.

6. Develop Mover Inventory.

7. Define mover responsibilities.

8. Identify items that will not fit in the elevators.

9. Identify existing furniture to be refinished/refurbished.

10. Schedule pickup/delivery of refinishing/refurbishing work.

Space Plan

A space plan allows for the intelligent planning and layout of the new location to accommodate workstation space requirements, phone jack locations, placement of furniture etc. For the space plan task 66, a listing of the activities associated therewith are as follows:

1. Identify Project Specific Activities that are not listed in the Relocation Planner.

2. Assign office/workstation space for each office staff.

3. Verify future office/workstation space required for growth.

4. Identify full height wall requirements.

5. Define insulation requirements in walls and ceilings.

6. Define soundproofing requirements.

7. Determine furniture power/data connection requirements.

8. Coordinate thermostat, light switches and fire extinguishers with furniture.

9. Identify electrical outlet locations at cabinets.

10. Identify voice/data jack locations.

11. Identify floor-mounted electrical outlets/connections.

12. Identify floor-mounted voice/data jacks.

13. Determine ceiling-mounted electrical requirements.

14. Locate electrical projection screens.

15. Determine cable television requirements.

16. Review audio visual requirements (including PA system).

17. Add new and existing furniture and equipment to the floor plan.

18. Add new and existing files to the floor plan.

19. Identify locations for office equipment, copiers, fax, printers, scanners, etc.

20. Identify area for mail room equipment.

21. Identify break rooms (coffee/tea stations).

22. Establish flooring protection for coffee overflows.

23. Identify required appliances (refrigerators, microwaves, dishwashers, etc.).

24. Determine water line requirements.

25. Determine plumbing requirements for hot/cold vending services.

26. Determine drain requirements for vending services.

27. Define keying requirements at cabinets (for storage of coffee, tea, supplies, etc.).

28. Define colors to be used for move labels (e.g., red, blue, green, etc.).

29. Develop color-coded floor plan.

30. Review Space Plan .pdf file.

Storage

On-site or off-site storage capacity is important when planning a move. Once equipment and furniture is moved, the new location must have storage capacity on or off-site, to accommodate everything. For the storage task 68, a listing of activities associated therewith are as follows:

1. Develop budget for new storage/shelving.

2. Identify Project Specific Activities that are not listed in the Relocation Planner.

3. Determine storage requirements (on-site and off-site).

4. Identify existing shelving to be reused.

5. Identify new shelving.

6. Select individual to provide/install shelving.

7. Define how new/existing shelving will be secured to walls and floor.

8. Confirm shelving installation process with Landlord/Building Property Manager.

9. Identify Landlord/Building Property Manager required shelving inspections.

10. Determine shelving permit requirements.

11. Identify shelving signage requirements (e.g., maximum load 100 lbs).

12. Select individual to secure new/existing shelving.

13. Schedule purchase of new shelving.

14. Define when to pack existing shelving.

15. Schedule delivery and installation of new/existing shelving.

16. Identify new and used shelving on the floor plan (to scale).

17. Establish who will have access to storage areas.

18. Determine level of security for storage areas.

19. Establish keying requirements for storage areas.

20. Determine off-site storage requirements.

21. Determine cancellation requirements for existing off-site storage agreements.

22. Identify existing off-site storage to be moved to the new facility.

23. Schedule to move off-site storage to new facility.

Vendors

Many companies use vendors to provide a whole list of equipment and services. For example, parking services at the new location may be provided by one vendor, while copying machines might be provided by another. Arrangements with vendors must be made prior to a move to make the move go smoothly. The vendor task insures that these arrangements are properly made. For the vendor task 70, a listing of activities associated therewith are as follows:

1. Develop budget for vendor services.

2. Identify Project Specific Activities that are not listed in the Relocation Planner.

3. Determine vendor requirements.

4. Develop list of existing equipment vendors (and services provided).

5. Develop list of existing vendor Lease/maintenance/monitoring agreements.

6. Identify modification terms for existing vendor agreements.

7. Identify sole point of contact to manage modification of existing and/or future vendor agreements.

8. Determine new Vendor Services required.

9. Identify vendors and services that will be used in the new facility.

10. Identify warranty issues related to moving existing vendor equipment (e.g., vending machines, copiers).

11. Schedule move of existing vendor equipment to the new facility.

12. Schedule pickup of existing vendor equipment to be returned.

13. Confirm space for vendor equipment.

14. Determine electrical, plumbing, mechanical, etc. requirements for vending equipment.

15. Confirm that vending machines fit through doorways at current and new facilities.

16. Identify existing artwork to be reused.

17. Determine how and when to remove existing artwork.

18. Determine new artwork requirements.

19. Develop plan to identify location of artwork.

20. Review artwork plan for conflicts with fire extinguisher cabinets, thermostats, switches, etc.

21. Select individual to install artwork at the new facility.

22. Schedule installation of new and existing artwork.

Under activity 8 above, an additional template is associated therewith and illustrated in FIG. 12. This template 166 is a table which represents a listing of vendor services to consider while completing the vendor task. The list shown is by no means exhaustive, but nevertheless further demonstrates a novel assembly of moving-related vendor services which comprise the inventive method.

Food Services

Many larger companies provide a kitchen and cafeteria for their employees, while smaller companies provide a break room with vending machines, coffee service or the like. These food services need to be arranged at the new location prior to moving. For the food services task 72 a listing of activities associated therewith are as follows:

1. Develop Food Services budget.

2. Identify Project Specific Activities that are not listed in the Relocation Planner.

3. Determine Food Service requirements.

4. Determine Health Department requirements.

5. Select individual to document and communicate key decisions.

6. Identify milestones and critical dates for new food service activities.

7. Confirm milestones and critical dates with contractor.

8. Coordinate vendor work schedules with contractor.

9. Confirm contractor milestones and critical dates for vendor.

10. Determine electrical, mechanical, plumbing, etc. requirements.

11. Identify Food Services equipment on plan (to scale).

12. Develop specification for Food Services equipment.

13. Develop Food Services bid.

14. Schedule pre-bid meeting with food services vendors.

15. Evaluate bids.

16. Award Food Services contract.

17. Issue purchase order (and deposit if required).

18. Schedule delivery and installation of Food Services equipment.

Computers II

The second computer task phase 74 details computer-related activities which need to be completed as a move nears. For example, now is the time to coordinate training for the office staff or to develop purge procedures for shared computer files. For the second computer task phase 74, a listing of activities associated therewith are as follows:

1. Identify Project Specific Activities that are not listed in the Relocation Planner.

2. Develop bid for computer vendor services.

3. Evaluate computer vendor bids.

4. Award computer equipment/service contracts.

5. Issue purchase order (and deposit if required).

6. Confirm inventory of existing computer equipment.

7. Confirm inventory of existing computer equipment.

8. Confirm that data cabling fits within systems furniture raceway.

9. Determine data cabling space requirements (if using systems furniture with power poles).

10. Specify requirements for early access to the new facility for set up/testing.

11. Determine who will have access to computer rooms/closets.

12. Determine requirements for plywood backboard (painted, treated, etc.).

13. Establish the labeling scheme for data jacks (coordinate with telephones).

14. Define process to relocate existing computer equipment scheduled to be reused.

15. Define who moves existing computer equipment scheduled to be reused.

16. Schedule move of existing computer equipment to be reused.

17. Define process for removing existing computer equipment not scheduled to be reused.

18. Define who removes existing computer equipment not being reused.

19. Schedule removal of existing computer equipment not being reused.

20. Schedule site meeting with computer vendors and contractor to review equipment layouts.

21. Schedule site deliveries using the Delivery Request Form (introduced in Project Launch).

Telephones II

The second telephones task phase 76 details telephone-related activities which need to be completed as a move nears. For the second telephones task phase 76, a listing of activities associated therewith are as follows:

1. Identify Project Specific Activities that are not listed in the Relocation Planner.

2. Develop bid for telephone vendor services (include audio visual services).

3. Evaluate telephone vendor bids.

4. Award telephone equipment/service contracts.

5. Issue purchase order (and deposit if required).

6. Confirm inventory of existing telephone equipment.

7. Confirm that telephone jack fits within systems furniture raceway.

8. Confirm that voice cabling fits within systems furniture raceway.

9. Determine voice cabling space requirements (if using systems furniture power poles).

10. Determine date for installation and testing of dedicated telephone lines.

11. Specify requirements for early access to the new facility for set up/testing.

12. Determine who will have access to telephone rooms/closets.

13. Establish the labeling scheme for telephone jacks (coordinate with computers).

14. Define process to relocate existing telephone equipment scheduled to be reused.

15. Define who moves existing telephone equipment scheduled to be reused.

16. Schedule move of existing telephone equipment to be reused.

17. Define process for removing existing telephone equipment not scheduled to be reused.

18. Define who removes existing telephone equipment not being reused.

19. Schedule removal of existing telephone equipment not being reused.

20. Determine telephone line cut over date.

21. Determine requirements for new pay telephones.

22. Schedule disconnect/reconnect of pay telephones.

23. Determine billing options (e.g., CD Rom) from telephone service vendor.

24. Schedule site meeting with telephone vendors and contractor to review equipment layouts.

25. Schedule site deliveries using the Delivery Request Form (introduced in Project Launch).

Security II

The second security task phase 78 details security-related activities which need to be completed as a move nears. Awarding a contract to a security company, issuing key cards to staff, and keying cabinets at the new location are all activities which need to completed. For the second security task phase 78, a listing of activities associated therewith are as follows:

1. Identify Project Specific Activities that are not listed in the Relocation Planner.

2. Evaluate security system bids.

3. Award security system contract to vendor.

4. Issue purchase order (and deposit if required).

5. Define format for end user information (e.g., for data input of office staff levels).

6. Define security access levels for office staff, consultants, etc.

7. Establish process for issuing temporary security cards (to contractors, visitors, temps, etc.).

8. Select individual responsible for key entry of end user security information.

9. Identify process to collect security end user information.

10. Define format for end user information (coordinate with security vendor).

11. Develop required security end user information.

12. Establish interior/exterior door keying schedule (coordinate with architect and contractor).

13. Establish millwork (e.g., cabinet) keying schedule.

14. Distribute keys, card keys, etc. to staff.

15. Establish process for returning existing keys, card keys, etc.

16. Determine training requirements for office staff (coordinate with security vendor).

17. Schedule security system training for office staff.

New Furniture II

The second new furniture task phase 80 details furniture-related activities which need to be completed as a move nears. Awarding a contract to a furniture vendor and arranging final delivery of furniture at the new location are all activities which need to be completed. For the second new furniture task phase 80, a listing of activities associated therewith are as follows:

1. Identify Project Specific Activities that are not listed in the Relocation Planner.

2. Evaluate furniture bids.

3. Review furniture mock-ups.

4. Perform math check to ensure correct bid amounts.

5. Identify any outstanding furniture items.

6. Award furniture contract.

7. Confirm availability of materials, fabrics, colors, etc.

8. Issue purchase order (and deposit if required).

9. Develop record plan identifying location and quantity of new furniture.

10. Review New Furniture Layout .pdf file.

11. Reconfirm furniture delivery/installation schedule with contractor.

12. Submit final furniture order and installation schedule.

13. Develop process to identify future modifications to the final furniture order.

14. Schedule on-site field measuring.

Seating Plan

A seating plan insures that employees will be properly situated at the new location near the resources and equipment which allow them to do their work most efficiently. For the seating plan task 82, a listing of activities associated therewith are as follows:

1. Identify Project Specific Activities that are not listed in the Relocation Planner.

2. Confirm office/workstation space for each office staff.

3. Confirm future office/workstation space required for growth.

4. Confirm access to files, storage, copiers, fax, printers, etc.

5. Formalize seating plan (place office staff names/numbers on plan using CAD).

6. Review floor plan numbering/labeling scheme (to be used by move vendor).

7. Review seating plan with telephone and computer Move Team members.

8. Develop process to manage future changes to seating plan.

9. Establish date for final seating plan revisions.

10. Provide future seating plan revisions to telephone and computer Move Team members.

Signage II

The second signage task phase 84 details signage-related activities which need to be completed as a move nears. A signage contract must be awarded to place signs at the new location and signs on the old location must be removed. For the second signage task phase 84, a listing of activities associated therewith are as follows:

1. Identify Project Specific Activities that are not listed in the Relocation Planner.

2. Evaluate signage bids.

3. Award signage contract.

4. Issue purchase order (and deposit if required).

5. Review signage mock-up.

6. Schedule installation of signage (coordinate with contractor).

7. Schedule removal of exterior and interior signage at current facility.

8. Identify need for electrician to disconnect existing signage.

9. Schedule electrician to disconnect existing signage.

Mover/Salvage

This task relates to contracting with a mover and hiring a salvage vendor. These activities are related, as the salvage vendor can remove much of the unwanted or outdated equipment, furniture and other items from the old location so that it lessens the burden on the mover who is moving items to the new location. For the mover/salvage task 86, a listing of activities associated therewith are as follows:

1. Develop budget for mover.

2. Identify Project Specific Activities that are not listed in the Relocation Planner.

3. Develop Mover Scope of Work.

4. Develop Dock/Elevator Access Exhibit.

5. Confirm pre/post-move insurance requirements with your insurance agent.

6. Determine equipment (e.g., copiers, etc.) that have to be moved by others to maintain warranty.

7. Schedule relocation of existing equipment to be moved by others.

8. Finalize Mover Inventory (developed in the Inventory Task icon).

9. Develop Preprinted Label Exhibit (based upon previously defined name/numbering scheme).

10. Develop Room Signage Exhibit.

11. Develop Building Protection Exhibit.

12. Develop Equipment Disconnect/Reconnect Scope Of Work.

13. Develop Computer/Telephone Trouble Indicator.

14. Develop Contractor Evaluation Sheet.

15. Determine activities to be completed by salvage vendor.

16. Determine electrical disconnect requirements for salvage activites.

17. Determine building protection requirements for the salvage vendor.

18. Schedule installation of building protection.

19. Determine building security/supervision requirements during salvage activity.

20. Develop mover/salvage vendor bid (to include contract requirements).

21. Schedule walk through date with potential mover/salvage vendors.

22. Review and award mover/salvage vendor contract.

23. Develop Salvage Schedule.

24. Confirm access for salvage vendor to current facility.

25. Coordinate salvage vendor dock/elevator usage with dock/elevator delivery schedule.

26. Verify traffic issues (e.g., commute times, parade routes, funerals, work construction, etc.).

Critical Factors II

For the second phase of the critical factors task 88, a listing of activities associated therewith are as follows:

1. Identify Project Specific Activities that are not listed in the Relocation Planner

2. Review status of construction.

3. Review status of elevator.

4. Review status of work required for occupancy permit.

5. Review status of telephone/computer services (e.g., dedicated lines, etc.).

6. Review status of cabling.

7. Review status of new furniture order.

8. Review status of new computer equipment.

9. Review status of new telephone equipment.

10. Review status of security system.

11. Review status of fire alarm monitoring system agreement.

12. Review status of signage.

13. Review status of other vendors (e.g., coffee, snacks, artwork, etc.).

14. Review data collected via Delivery Request Form (introduced in Project Launch).

15. Develop and distribute the Dock/Elevator Delivery Schedule.

16. Identify date to transfer new utilities into your name.

17. Identify date to cancel existing utilities at current facility.

18. Identify insurance requirements for internal pre/post-move.

19. Select individual responsible for damage/theft at new facility prior to the move.

20. Confirm that office staff names have been identified on the seating plan.

21. Review parking lot requirements (e.g., speed bumps, signage, striping, etc.).

22. Develop contingency plan for temporary telephones, computers, furniture, etc.

Purge I

Purging relates to eliminating or recycling unneeded documents. Paper documents especially contribute to the physical weight of a move. The first phase of the purge task involves planning the purge event. FIG. 13 illustrates a template 166 showing a number of purge guidelines based upon the age and character of the document. FIG. 14 illustrates a purge/recycling schedule template 166 for a multi-storied building, suggesting starting the purging at the top floor and working down. For the first purge task phase 90, a listing of activities associated therewith are as follows:

1. Identify Project Specific Activities that are not listed in the Relocation Planner.

2. Select individual as sole point of contact for purge/recycling activities.

3. Select individual to document and communicate key decisions.

4. Determine how to phase the purge/recycling activities.

5. Develop simple purge guidelines for paper files, computer files and supplies.

6. Define Materials Management Guidelines for your office staff.

7. Determine when purge activities will occur (e.g., during work, after work, etc.).

8. Identify the need for a purge vendor.

9. Plan disposal of confidential materials.

10. Plan archiving of historical items.

11. Identify need for purging of off-site and archived files.

12. Determine additional dumpster requirements.

13. Develop Purge/Recycling Recommendations.

14. Develop Purge/Recycling Schedule.

Filing Systems

Files contain important client and customer information or sensitive material and must be protected, accounted for, and properly placed during an office move. For the filing systems task 92, a listing of activities associated therewith are as follows:

1. Identify Project Specific Activities that are not listed in the Relocation Planner.

2. Define new filing requirements.

3. Review Filing Tips.

4. Develop layout for each shelf/bookcase/file.

5. Address requirements for confidential files.

6. Establish who will have access to files.

7. Determine new files to be purchased.

8. Select individual to provide/install new files.

9. Determine how files will be secured to floors and walls.

10. Schedule delivery and installation of files.

11. Consider file conversion opportunities (e.g., CD Rom).

12. Establish filing method (e.g., side-to-side, front-to-back, top tab, side tab, etc.).

Janitorial

Janitorial requirements can change in moving from one facility to another. At the old location, the existing janitorial services must be terminated and a new janitorial vendor must be commissioned at the new location. Building layout may dictate a whole host of new janitorial and recycling requirements. For the janitorial task 94, a listing of activities associated therewith are as follows:

1. Identify Project Specific Activities that are not listed in the Relocation Planner.

2. Determine new janitorial requirements.

3. Develop janitorial bid.

4. Schedule pre-bid meeting with janitorial vendors.

5. Evaluate janitorial bids.

6. Award janitorial contract.

7. Issue purchase order (and deposit if required).

8. Select date for supplying restroom supplies in new facility (prior to move).

9. Select last day for current janitorial services.

10. Schedule date for janitorial services to dump trash prior to the move.

11. Identify garbage vendor for new facility.

12. Consider need for extra dumpster during the move into new facility.

13. Identify size and quantity of dumpsters for new facility.

14. Order new dumpsters and establish dumping schedules.

15. Determine recycling requirements.

16. Address office trash receptacles.

17. Address additional dumpster requirement at new facility (for move only).

Landscaping

Landscaping services must be arranged at the new facility and terminated at the old one. For the landscaping task 96, a listing of activities associated therewith are as follows:

1. Identify Project Specific Activities that are not listed in the Relocation Planner.

2. Determine new landscaping requirements.

3. Address requirements for parking lot sweeping and maintenance.

4. Develop landscape bid.

5. Schedule pre-bid meeting with landscape contractors.

6. Evaluate landscape bids.

7. Award landscape contract.

8. Issue purchase order (and deposit if required).

9. Confirm current landscape warranty.

10. Review existing landscaping services agreement.

11. Establish cancellation terms of current landscaping services agreement.

12. Select last day current landscaping services will be needed.

Purge II

For the second phase of the purge task 98, a listing of activities associated therewith are as follows:

1. Develop budget for purge activities.

2. Identify Project Specific Activities that are not listed in the Relocation Planner.

3. Develop vendor bids for purge/recycling services.

4. Schedule pre-bid meeting with purge/recycling vendors.

5. Evaluate bids.

6. Award purge/recycling contract.

7. Issue purchase order (and deposit if required).

8. Schedule dock/elevator usage for purge vendor.

9. Identify locations of purge receptacles.

10. Establish access to current facility for purging activity.

11. Develop communication plan with staff for purge activities.

12. Establish appropriate dress code for purge activities.

13. Complete and hang Purge/Recycle Staff Notification.

14. Complete and hang Purge/Recycle Container Guidelines.

15. Schedule delivery/pickup of additional dumpster (if required).

Mail

Arrangements for handling mail must be made at the new location such as setting up a mail room, acquiring postal equipment, etc. For the mail task 100, a listing of activities associated therewith are as follows:

1. Identify Project Specific Activities that are not listed in the Relocation Planner.

2. Establish how and where mail will be collected and shipped.

3. Establish how and where overnight mail will be collected and shipped.

4. Determine mail equipment requirements.

5. Confirm that mail equipment will fit in designated space.

6. Identify dedicated lines for mail equipment.

7. Confirm electrical requirements for mail equipment.

8. Establish storage area for mail supplies.

9. Establish how mail will be sorted and delivered internally.

10. Select a location for storing mail carts.

11. Verify requirements for internal mail drop-off stations.

12. Identify any special move requirements for mail equipment.

Move Activities

For the move activities task 102, a listing of activities associated therewith are as follows:

1. Identify Project Specific Activities that are not listed in the Relocation Planner.

2. Define Dock Master Roles and Responsibilities.

3. Define Move Coordinator/Floor Monitor Roles and Responsibilities.

4. Identify Move Coordinators.

5. Identify Floor Monitors.

6. Determine location of move signage (e.g., door frame, workstation panel, etc.).

7. Determine materials required to post move signage (e.g., t-pins, painters tape, etc.).

8. Determine time to shut down copiers and postage equipment.

9. Schedule move of vending machines.

10. Schedule move of copiers.

11. Schedule move of postage equipment.

12. Develop Move Schedule.

13. Distribute Move Schedule.

Move Notices

Upon moving, clients, vendors, and others need to be given notice of the address, phone, and fax of the new location. As a result, yellow page listings, business cards, post office address, letterhead, etc. all need to be updated with new information relating to the new location. For the move notices task 104, a listing of activities associated therewith are as follows:

1. Identify Project Specific Activities that are not listed in the Relocation Planner.

2. Develop process for creating new business cards, forms, letterhead, envelopes, etc.

3. Reconfirm new address, e-mail, telephone and fax numbers prior to placing order.

4. Order business cards, forms, letterhead, etc. after telephone lines have been installed.

5. Develop process for distribution of new printed materials.

6. Provide change of address to Post Office and overnight mail vendors.

7. Provide change of address for Yellow Pages, White Pages, etc.

8. Revise web site address and other on-line materials.

9. Develop a plan for notification of move to clients, vendors, etc.

10. Develop and schedule press release.

11. Order new checks.

12. Develop new fax cover sheets.

Pre-Install

Items such as phones, cabling and furniture must be installed at the new location. Often, these items are removed from the old location and installed at the new. Pre-installation planning includes arranging vendors to perform the installations and any logistics related thereto. For the pre-installation task 106, a listing of activities associated therewith are as follows:

1. Identify Project Specific Activities that are not listed in the Relocation Planner.

2. Develop Pre-Install Agenda.

3. Identify participants of pre-installation meeting (e.g., general contractor, furniture vendor, etc.).

4. Schedule pre-installation meeting at the new facility.

5. Identify sole point of contact to take meeting notes and distribute to meeting participants.

6. Confirm special equipment required by furniture vendor (e.g., forklift, cage, etc.).

7. Confirm equipment operator required.

8. Define weatherproofing requirements.

9. Identify who will provide and install temporary loading ramp (for furniture delivery).

Move Packet

It is important to communicate details of the move with employees and provide them with items they will need to make the move go smoothly. For example, providing employees with furniture labels insures that the right furniture goes to the right employee's cubicle at the new location; providing employees with a new telephone/fax list insures that they will be able to communicate with each other once they are settled into their new work environment; providing them with security card keys insures they will have access to their new workplace. These items can be placed in a move packet, such as a large envelope, and given to the employees. For the move packet task 108, a listing of activities associated therewith are as follows:

1. Identify Project Specific Activities that are not listed in the Relocation Planner.

2. Develop Move Packet.

3. Develop new facility guidelines to include in move packet (e.g., smoking, heavy perfume, parking, etc.).

4. Verify receipt of pre-printed labels from move vendor.

5. Verify receipt of security card keys.

6. Verify receipt of telephone/fax list.

7. Schedule copying of move packet for Move Team members.

8. Reserve conference room for assembly of move packets.

9. Schedule Move Team members to assist with move packet assembly.

10. Develop labels (with staff names) for move packet envelope.

11. Purchase move packet envelopes.

12. Select and purchase clips, chains, etc. required for security card keys.

13. Develop distribution schedule for move packets.

14. Provide carts for distribution of move packets

Training

Training programs for such items as new telephone systems, security systems, lighting and HVAC need to be instigated so that employees know how to operate these items at the new facility. For the training task 110, a listing of activities associated therewith are as follows:

1. Identify Project Specific Activities that are not listed in the Relocation Planner.

2. Schedule office staff orientation tours at new facility.

3. Identify areas for which training is required (e.g., telephone, security, lights, HVAC, etc.).

4. Identify areas for which training is required (e.g., telephone, security, lights, HVAC, etc.).

5. Select individuals to facilitate office staff training sessions.

6. Develop training programs.

7. Select location of training sessions.

8. Determine how to divide office staff between training sessions.

9. Schedule office staff training.

10. Schedule initial fire evacuation drill at new facility.

Computers III

The third computer task phase 112 details computer-related activities which need to be completed directly prior to a move. For example, now is the time to conduct training for the office staff or to terminate an existing computer services contract. For the third computer task phase 112, a listing of activities associated therewith are as follows:

1. Identify Project Specific Activities that are not listed in the Relocation Planner.

2. Determine training requirements for office staff (e.g., e-mail, etc).

3. Develop training program for office staff

4. Schedule training for office staff.

5. Determine time to shut down computer equipment for the disconnect/reconnect process.

6. Coordinate computer shut down time with the Project Manager.

7. Coordinate computer shut down time with Move Team members.

8. Develop process for purging shared computer files.

9. Implement computer purge process.

10. Confirm process for forwarding/cancelling current computer services.

11. Schedule forwarding/cancelling of current computer services.

12. Return leased computer equipment.

13. Collect Equipment Placement Forms (see Move Packet).

14. Review Trouble Ticket (see Move Packet).

15. Develop process to determine routing for shared printers and other devices.

16. Identify team to implement routing process during the move.

Telephones III

The third telephones task phase 114 details telephone-related activities which need to be completed as prior to a move, such as arranging telephone cutover with the phone company or returning lease telephone equipment. For the third telephones task phase 114, a listing of activities associated therewith are as follows:

1. Identify Project Specific Activities that are not listed in the Relocation Planner.

2. Confirm dedicated telephone lines have been ordered.

3. Determine training requirements for office staff.

4. Develop training program for office staff.

5. Schedule training for office staff.

6. Confirm telephone line cutover date and time.

7. Develop process for forwarding/cancelling telephone/fax/modem lines.

8. Develop process for reprogramming fax machines (including header).

9. Develop new telephone/fax extension list.

10. Return leased equipment.

11. Review Equipment Placement Forms (see Move Packet).

12. Review Trouble Ticket (see Move Packet).

Installation

Most of the arrangements for installation were laid during the pre-install task, however installation requires that arrangements are reconfirmed with the vendors so that everything goes smoothly during the move. For the installation task 116, a listing of activities associated therewith are as follows:

1. Identify Project Specific Activities that are not listed in the Relocation Planner.

2. Review pre-install agenda meeting notes with contractor and vendors.

3. Reconfirm Dock/Elevator Delivery Schedule (developed in the Critical Factors icon).

4. Reconfirm site deliveries with contractor.

5. Reconfirm status of construction schedule.

6. Reconfirm person(s) accepting facility deliveries.

7. Reconfirm furniture vendor installation.

8. Reconfirm sign vendor installation.

9. Reconfirm cabling vendor installation.

10. Reconfirm Move Team member (computer and telephone) set up and testing schedule.

Deliveries

Deliveries of furniture, office equipment and vendor items must be arranged for a move. Building and dock access has to be organized. Elevators must be in operation to deliver items to upper floors and staging areas for unloading trucks have to be developed. For the deliveries task 118, a listing of activities associated therewith are as follows:

1. Identify Project Specific Activities that are not listed in the Relocation Planner.

2. Confirm Move Team member contact for deliveries at current facility.

3. Confirm staging location for move vendor boxes and equipment.

4. Confirm quantity of move vendor boxes and equipment.

5. Confirm possession of keys for staging areas.

6. Confirm building and dock access with Landlord/Building Property Manager.

7. Confirm path of travel for move vendor box and equipment deliveries.

8. Confirm staging/unloading areas for move vendor trucks.

9. Confirm building and elevator protection requirements during move vendor equipment delivery.

10. Confirm possession of elevator keys.

Pre-Move

Directly prior to a move, a checklist of relevant items needs to be completed. The list of pre-move activities comprising the pre-move task 120 is as follows:

1. Identify Project Specific Activities that are not listed in the Relocation Planner.

2. Review status of remaining construction.

3. Review status of elevator.

4. Review status of work required for occupancy permit.

5. Review status of telephone/computer services (e.g., dedicated lines, etc.).

6. Review status of cabling.

7. Review status of new furniture installation.

8. Review status of new computer equipment.

9. Review status of security system testing.

10. Review status of fire alarm monitoring system agreement.

11. Review status of signage.

12. Review status of other vendors.

13. Review status of dock/elevator delivery schedule.

14. Schedule pre-move inspection with move vendor.

15. Complete Pre-Move Inspection form.

16. Schedule a practice disconnect/reconnect of computers and telephones.

17. Confirm labeling of items (e.g., furniture, fixtures and equipment) scheduled to move.

18. Develop and post directional signage for move vendor.

19. Provide Move Team members with a copy of space plan for sign hanging activities.

20. Post Equipment Placement Forms at the new facility.

21. Post floor layouts for hard wall offices, break rooms, storage rooms, file rooms, etc., at the new facility.

22. Reconfirm move schedule with Move Team members.

23. Review Dock Master Roles and Responsibilities (developed in the Move Activities icon).

24. Review Move Coordinator/Floor Monitor Roles and Responsibilities (developed in the Move Activities icon).

25. Obtain security access codes, clearance, etc.

26. Obtain door/elevator keys at current and new facilities.

27. Schedule lights, AC, etc., during physical move for current and new facilities.

28. Schedule vendors (e.g., electrician, cabling, furniture, etc.) for troubleshooting during the move.

29. Confirm security guards.

30. Confirm emergency elevator backup plan.

31. Establish policy for unclaimed items.

32. Select area on each floor for temporary storage of unclaimed items.

33. Prep postage equipment.

34. Prep copier(s).

35. Confirm the relocation of copiers by others.

36. Confirm the relocation of postage equipment by others.

37. Confirm the relocation of vending machines by others.

38. Confirm the installation of new and existing artwork.

39. Return leased furniture/equipment.

40. Post current Human Resource/Employment notices as required.

41. Schedule food order and delivery for Move Team members and movers.

42. Define current facility shut down/lockup requirements during the move (e.g., arm security system, etc.).

43. Define new facility shut down/lockup requirements during the move (e.g., arm security system, etc.).

44. Identify sole point of contact for shutdown/lockup of current facility during the move.

45. Identify sole point of contact for shutdown/lockup of new facility during the move.

Move

For the move task 122, the following activities apply:

1. Identify Project Specific Activities that are not listed in the Relocation Planner.

2. Confirm that move vendor is in uniform (crew and supervisor).

3. Confirm Move Team member identification.

4. Identify security requirements.

5. Verify that move vendor is on schedule for computer disconnect/reconnect activities.

6. Establish move vendor break and lunch times.

Post-Move

After the move has occurred, the post move task involves items such as checking for damage on equipment or furniture and managing salvage activities at the old facility. For the post-move task 124, a listing of activities associated therewith are as follows:

1. Identify Project Specific Activities that are not listed in the Relocation Planner.

2. Remove directional signage.

3. Tour the current and new facilities with the move vendor.

4. Complete a Post-Move Inspection form with move vendor.

5. Confirm Move Team members scheduled to direct movers on the first day of business after the move.

6. Confirm Move Team members scheduled to assist office staff.

7. Confirm Move Team members scheduled to address Trouble Ticket issues.

8. Confirm Move Team members scheduled to manage salvage activities at the existing facility.

9. Identify additional dumpsters required.

Cleanup

Cleanup is the final task in the inventive relocation method. Removal of trash at the old facility, performing a walk-through with the prior landlord and scheduling a post-move cleanup crew are some of the items which need to be completed with this last step. For the cleanup task 126, a listing of activities associated therewith are as follows:

1. Identify Project Specific Activities that are not listed in the Relocation Planner.

2. Define last day and time to physically occupy existing facility.

3. Define last day and time to physically occupy existing facility.

4. Define last day and time to physically occupy existing facility.

5. Schedule a post-move clean-up crew.

6. Schedule building/dock/elevator access for post-move activities.

7. Schedule final cleaning by janitorial service.

8. Develop “We have moved” signs.

9. Coordinate with Landlord/Building Property Manager for placement of

10. Arrange for disposal of remaining trash (e.g., additional dumpster).

11. Schedule meeting with Landlord for final walk through.

12. Complete Landlord Final Walk Through form.

13. Identify sole point of contact to transfer/cancel utilities and/or services.

14. Remove move labels from furniture and equipment at new facility.

15. E-mail bcs@bcsfmg.com with your comments on the Relocation Planner.

Referring now to FIG. 15, the activity search function 168 can be described. As part of the program, a search engine 170 is provided to allow information regarding a certain aspect of a relocation project to be readily accessed and a variety of useful reports generated. In the preferred embodiment, the search function 168 allows information regarding tasks 172, activities 174, persons responsible for an activity 176 and due dates for activity completion 178 to be searched and organized into the reports further described herein.

FIG. 16 is an exemplary web page showing an activity report 180, which results when an activity keyword 182 and a person responsible 184 is entered into the search engine 170. As shown, entering the keyword “landlord” and person responsible (e.g. “Steve Roper”) pulled up all activities 186, tasks 188, and due dates 190 associated with that person and keyword. Anything having to do with a landlord and Steve Roper, the responsible person, is displayed. The activity description 192 can appear as a web link to allow the user to access a web page of the type shown in FIG. 4, listing all the activities associated with the task. This activity search function allows a project manager to have an audit trail of work completed. Also, if a person assigned to an activity leaves the project, the project manager can always easily find out where that person left off, and thereby continue that person's assigned tasks in a seamless manner.

FIG. 17 is an exemplary web page showing an activity due date summary report 194, which results when a date range 196 is entered into the search engine 170. As shown, the date range 196 is a single day (Nov. 7, 2002) and the search engine displays tasks 188 and their associated activities 186 and persons responsible 184 for that date range. The report shown in FIG. 17 is for a “high-access” individual, such as a project manager, who would have a need to know which activities and persons responsible are pending for a particular date range. The project manager could then take appropriate action to keep the project on track, based upon the information displayed in the report.

FIG. 18 is an exemplary web page showing a member login report 198 which result when a date range 196 and a person responsible 184 is entered into the search engine 170. Here, for a date range of between Sep. 15, 2002 and Oct. 15, 2002, Steve Roper, the responsible person, logged in numerous times. The report gives the date of login 200 and the IP address 202 from where the login 204 occurred. Logouts 206 are also provided in the report so that a project manager or other high-access individual could determine the length of time the responsible person spent online attending to the completion of various activities.

The invention provides a comprehensive and systematic approach to office relocations by identifying the specific activities to be performed in the office relocation and the internal processes required to make timely purchasing decisions for staff, contractors, vendors, furniture, and equipment. The invention identifies over 400 activities designed to efficiently move an office; prioritizes, on a weekly basis, move activities according to the move date; allows the management of the completion of activities while allowing move team members “read only” access. The invention enhances communication with move team members, vendors, and staff. The preferred embodiment is a Web-based application, having calendar, task, and template and project summary formats that are easy to understand. Icons allow easy file management of all daily or weekly tasks and associated templates. Color coordination defines the relationships among calendars, tasks, and templates. Customized templates provide examples, sample formats, reminders, questions to ask, and items to consider. The invention allows tasks and templates to be printed. The invention allows selected templates to be downloaded, modified, and uploaded.

The method comprises at least a novel minimum of the following steps: selecting a project start date on a calendar time line to begin the completion of various tasks and activities associated with an office move; obtaining the anticipated date of the office move; identifying tasks and activities to be competed at particular times with respect to the date of the office move; assigning person responsible and due dates to the predefined tasks and activities; identifying the internal processes required to complete the tasks and activities; prioritizing the tasks; customizing activities; providing a schedule of dates by which the tasks and activities should be completed, based on the anticipated date of the move and the prioritization of the tasks and activities; for a task, providing a list of decisions to be made in order to complete the task; for a task, providing a template to assist in the performance of the task; tracking the performance and completion of the tasks and activities; providing a person (user) with access to the schedule; providing the opportunity to limit access to the schedule; updating the tracking of the performance and completion of the tasks and activities; and storing the schedule and tracking information.

The systems and methods disclosed herein illustrate the principles of the present invention. The invention may be embodied in other specific forms without departing from its spirit or essential characteristics. The described embodiments are to be considered in all respects as exemplary and illustrative rather than restrictive. Therefore, the appended claims rather than the foregoing description define the scope of the invention.

1. A method for tracking the completion of a task along a time line, comprising:
a) selecting a start date on the time line;
b) selecting at least one task to be completed;
c) identifying the task with a task icon;
d) placing the task icon on a date located on the time line;
e) prioritizing the task icon in relation to a plurality of other task icons on the time line
f) displaying a present date on the time line; and
g) coordinating the task icon on the time line with the present date.

2. A computer readable medium comprising the method of claim 1.

3. A method for tracking the completion of at least one task on a time line, comprising:
a) providing a computer program for executing the steps of:
i) selecting a start date on the time line;
ii) selecting at least one task to be completed;
iii) selecting a desired date on the time line for completing the task;
iv) indicating a present date on the time line;
v) indicating the position of the present date in relation to the desired task completion date on the time line; and
vi) indicating an actual task completion date on the time line.

4. The method of claim 3, wherein the computer program further executes the step of selecting an individual to complete the task.

5. The method of claim 3, wherein step (a)(vi) is accomplished by placing a check mark on the task completion date on the time line to indicate actual task completion.

6. The method of claim 5, wherein step (a)(iv) is accomplished by coloring the present date red on the time line.

7. A method for tracking the completion of at least one task on a time line, comprising:
a) providing a computer program for executing the steps of:
i) providing a time line in the form of a calendar;
ii) tracking the full completion of at least one task along the time line, the task being broken down into a plurality of activities;
iii) indicating the completion status of the activities; and
iv) indicating on the time line when full completion of all the activities has been accomplished.

8. The method of claim 7, further comprising the step of indicating on the time line the date on which each activities is to be accomplished.

9. A method for managing the completion of tasks in a project, while providing a level of security to certain types of information, comprising:
a) providing a computer program for executing the steps of:
i) assigning a project manager with high access to said computer program who can designate a task as being completed;
ii) assigning a staff person with more limited access to said computer program than said project manager who can designate a task as being in progress but who cannot designate a task as being completed;
iii) wherein said project manager can access budget information on said project; and
iv) assigning a vendor with more limited access to said computer program than said project manager, said vendor being unable to access said budget information.

10. A method for conducting and managing an office move, comprising::
a) providing a computer program for executing the steps of:
i) entering an anticipated date of the office move;
ii) identifying tasks and activities to be completed at particular times with respect to the anticipated date of the office move;
iii) identifying the internal processes required to complete the tasks and activities;
iv) prioritizing the tasks and activities;
v) providing a schedule of dates by which tasks and activities should be completed based upon the anticipated date of the move and the prioritization of the tasks and activities
vi) for a task, providing a list of decisions to be made in order to complete the task;
vii) for a task, providing a template to assist in the performance of the task; and
viii) tracking the performance and completion of the tasks and activities.

11. The method of claim 10, wherein the computer program further executes the step of providing a person with access to the schedule.

12. The method of claim 11, wherein the computer program further executes the step of providing the opportunity to limit access to the schedule.

13. The method of claim 12, wherein the limited access that is provided is read-only access.

14. The method of claim 10, wherein the computer program further executes the step of updating the tracking and performance and completion of the tasks and activities.

15. The method of claim 10, wherein the computer program further executes the step of storing the schedule and tracking information.

16. The method of claim 10, wherein the computer program further executes the step of providing a one-page overview of completed vs. outstanding tasks.

17. The method of claim 10, wherein the computer program further executes the step of identifying the steps and time associated with the procurement of products and services.

18. The method of claim 10, wherein the computer program further executes the step of detailing the scope of work provided by a vendor.

19. The method of claim 10, wherein the computer program further executes the step of providing an audit trail of key activities and the names of persons responsible for completing the activities.

20. A method for tracking the completion of at least one task on a time line, comprising:
a) selecting a start date on the time line;
b) selecting at least one task to be completed;
c) selecting a desired date on the time line for completing the task;
d) indicating a present date on the time line;
e) indicating the position of the present date in relation to the desired task completion date on the time line; and
f) indicating an actual task completion date on the time line.

21. A method for tracking the completion of at least one task on a time line, comprising:
a) providing a computer program for executing the steps of:
i) selecting a start date on the time line;
ii) selecting at least one task to be completed;
iii) selecting a desired date on the time line for completing the task;
iv) indicating a present date on the time line;
v) indicating the position of the present date in relation to the desired task completion date on the time line; and
vi) indicating an actual task completion date on the time line.

22. The method of claim 21, wherein the computer program further executes the step of selecting an individual to complete the task.

23. The method of claim 21, wherein step (a)(vi) is accomplished by placing a check mark on the task completion date on the time line to indicate actual task completion.

24. The method of claim 21, wherein step (a)(iv) is accomplished by coloring the present date red on the time line.

25. A method for tracking the completion of at least one task on a time line, comprising:
a) providing a computer program for executing the steps of:
i) providing a time line in the form of a calendar;
ii) tracking the full completion of at least one task along the time line, the task being broken down into a plurality of activities;
iii) comparing the completion status of the activities with a present date on the time line; and
iv) indicating on the time line when full completion of all the activities has been accomplished.

26. The method of claim 25, further comprising the step of indicating on the time line the date on which each activity is to be accomplished.

27. A method for managing the completion of tasks in a project, while providing a level of security to certain types of information, comprising:
a) providing a computer program for executing the steps of:
i) assigning a project manager with high access to said computer program who can designate a task as being completed;
ii) assigning a staff person with more limited access to said computer program than said assigned project manager who can designate a task as being in progress but who cannot designate a task as being completed;
iii) wherein both said project manager and said staff person can access budget information on said project; and
iv) assigning a vendor with more limited access to said computer program than said project manager and who cannot access said budget information on said project.

28. A computer-readable medium for causing a computer to function as a relocation planner, comprising:
a computer program stored on said computer-readable medium;
said computer program having an interface for accessing a database of relocation tasks associated with a relocation project;
said computer program having an interface for accessing a database of activity records, said activity records containing data describing activities which need to be completed in order to complete a one of said relocation tasks;
said computer program having a processing module for keeping track of the completion status of said relocation tasks and for designating a relocation task on said time line as being completed when said task's associated activities have been completed.

29. The computer readable medium of claim 28, wherein said computer program is further described as having a processing module for placing said tasks on a calendar time line

30. The computer readable medium of claim 29, wherein said computer program is further described as having a processing module for moving a task designated as being completed from a first location on said time line to a second location on said time line.

31. The computer readable medium of claim 30, wherein said second location is a date on said time line marked with a check mark designating completion of said task.

32. The computer readable medium of claim 28, wherein said computer program is further described as having a processing module for taking said tasks designated as completed and displaying them along with said uncompleted tasks upon a computer program interface in a summary format.
